(19) United States
(12) Patent Application Publication
(10) Pub. No.: US 2008/0284950 A1
(43) Pub. Date: Nov. 20, 2008

(54) COMPOSITION, SINGLE LAYER, MEMBER OR LAMINATE FOR REALIZING AN ANTISTATIC (AND HARDCOAT) FEATURES

(75) Inventor: Kiyoshi Itoh, Sagamihara-Shi (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 12/059,004

(22) Filed: Mar. 31, 2008

(30) Foreign Application Priority Data
Apr. 2, 2007 (JP) 2007-096688
Apr. 2, 2007 (JP) 2007-096695
Apr. 2, 2007 (JP) 2007-096707
Apr. 2, 2007 (JP) 2007-096711
Apr. 2, 2007 (JP) 2007-096715
Apr. 2, 2007 (JP) 2007-096717
Apr. 2, 2007 (JP) 2007-096721

(51) Int. Cl. H01B 1/12; G02B 1/08

(52) U.S. Cl. 349/96; 252/500

(57) ABSTRACT

This invention proposes an antistatic composition. The antistatic composition comprises an ionic liquid, which is liquid at room temperature, as an electrolyte and a resin.

### RELATED APPLICATION

This application is based upon and claims the benefit of priority under the Paris Convention from the prior Japanese Patent Applications No. 096688/2007, No. 096717/2007, No. 096715/2007, No. 096721/2007, No. 096695/2007, No. 096707/2007, and No. 096711/2007; the entire contents of which are incorporated herein by reference.

### TECHNICAL FIELD

The present invention relates to a composition, a (optical) single layer material, a (optical) member, or a (optical) laminate having antistatic properties or a combination of antistatic properties with hard coat properties, for use in the field where a combination of antistatic properties with hard coat properties, or antistatic properties are required, especially in the field of materials, optics, home electric appliances, building materials, clothings, vehicles, precision mechanical equipment and the like (particularly in the field of optics).

### BACKGROUND ART

### Common Background Art

Various products subjected to antistatic treatment have hitherto been developed, for example, in the field of vehicles, home electric appliances, building materials, and clothings and have been put on the market. In home electric appliances, among others, a protective film comprising a plurality of optical function layers (films), which exhibit functions such as antistatic properties (dust deposition prevention), hard coat properties (scratch resistance), antireflection properties (improved visibility), anti-dazzling properties (dazzling preventive properties), and antifouling properties (fingerprint deposition prevention), stacked on top of each other has recently been developed for use on image display surfaces (displays) in image display devices, for example, cathode-ray tube display devices (CRTs), plasma displays (PDPs), electroluminescent displays (ELDs), field emission displays (FEDs), or liquid crystal displays (LCDs) (Japanese Patent Laid-Open No. 248712/2002).

First to Fourth Aspects of Present Invention

Hard coat properties and antistatic properties (dust deposition prevention) may be particularly mentioned as functions required of protective films applied onto the surface of displays and monitors. In protective films, in order to develop both the above properties, it is a common technical practice to stack two layers of a hard coat layer and an antistatic layer on top of each other. It has been recognized that the development of a layer having both the above properties (a single layer) is impossible. Chemical and physical properties required of materials for forming the hard coat layer and the antistatic layer have been regarded to be substantially contradictory to each other, and, thus, a person having ordinary skill in the art has of course recognized that the realization of a layer which simultaneously has both the above properties is impossible. Specifically, when an ion conductive material is added for antistatic purposes and a material (a monomer) for enhancing the film density is selected for hard coat property improvement purposes followed by curing, any passage, for ions to be conducted in the formed cured film could not have been ensured and the development of antistatic properties has been regarded to be substantially impossible. Further, the following matter has been pointed out. When electron conductive materials are used for antistatic purposes, most of the electron conductive materials are a water-based material. Accordingly, increasing the amount of the electron conductive material for conductivity improvement purposes results in significantly lowered affinity for a material having hard coat properties which is mainly of a solvent type and accelerates component separation. As a result, hard coat properties cannot be developed at all.

For the above reasons, in order to simultaneously realize antistatic properties and hard coat properties, it has been common technical practice to stack two layers, i.e., a hard coat layer and an antistatic layer, on top of each other. In an optical laminate comprising the two layers or a combination of the two layers with other optical function layers (for example, an antifouling layer and a refractive index layer), various optical problems, for example, optical scattering-derived internal and external scattering, optical interferences, interference fringes, a variation in refractive index in lamination interface, and optical cause-derived coloring, have naturally occurred. Solving the above problems has hitherto been regarded as an important task in the field of optical laminates, and, to this end, various technical developments have been made (Japanese Patent Laid-Open No. 50535/2004).

If an optical single layer material, which can exhibit a plurality of optical properties, can be realized without stacking a plurality of optical function layers having various functions for forming an optical laminate, the above optical problems could be solved. In this case, further, the production cost could be significantly reduced because the production process becomes easy and simple.

Accordingly, the present inventors have aimed at a technical task of realizing a composition, a (optical) single layer material, a (optical) member, or a (optical) laminate, simultaneously having antistatic properties and hard coat properties, as opposed to such common conventional technical recognition that, in order to simultaneously realize antistatic properties and hard coat properties, two layers of an optical function layer having antistatic properties and an optical function layer having hard coat properties should be always stacked, in other words, that the provision of a single layer simultaneously having both antistatic properties and hard coat properties cannot be realized. As a result, the above problems of the prior art have been solved at the time of the present invention.

Fifth to Seventh Aspects of Present Invention

In the prior art technique, the antistatic layer comprises an antistatic agent, a resin, and a solvent (Japanese Patent Laid-Open No. 257254/2003). More properly dispersing, within the antistatic layer, an antistatic agent in a resin in such a manner that the antistatic agent is not present as an aggregate, however, is indispensable. Accordingly, it has been recognized that, in the preparation of the dispersion liquid, for example, proper antistatic agents, resins, and solvents should be selected. Among others, when metallic fine particles are used, for example, settling velocity and dispersibility should be satisfactorily taken into consideration. Further, since most of the metallic fine particles belong to rare metals, the utilization of the metallic fine particles has led to an increase in production cost of the antistatic member. On the other hand, when organic fine particles such as electroconductive polymers are used, the preparation of the dispersion liquid is easier that in the case where the metallic fine particles are used. Accordingly, the range of selection of usable resins and the like is preferably broadened. On the other hand, the organic fine particles colors the antistatic layer per se, and, thus, have been regarded as unsuitable for products where transparency is required (Japanese Patent Laid-Open No. 45360/2006).

The antistatic layer formed by coating an ink composition, produced by dispersing these fine particles in a resin and the like, on a surface of a base material is generally formed, for example, as a roll from the viewpoint of easiness on transfer to the next step. In forming the roll, in order to effectively prevent the separation and chipping of the fine particles as the antistatic agent from the antistatic layer, enhancing the hardness of the coating film has been required. Accordingly, for example, coating of the composition, for an antistatic layer with the fine particles dispersed therein, on a surface of a light-transparent base material and curing of the resin should be properly carried out. Thus, troublesome steps were necessary for antistatic layer formation. Further, the electrical conductivity on the surface of the conventional antistatic layer is in most cases on the order of more than 1×10¹⁰ and not more than 1×10¹³ Ω/cm², and an antistatic layer having an electrical conductivity of not more than 1×10¹⁰ Ω/cm² and less than 1×10¹⁰ Ω/cm² has not been realized.

At the present time, the development of an antistatic composition, which can realize a high electrical conductivity of less than 1×10¹⁰ Ω/cm², has good compatibility, for example, with resins and solvents, has excellent dispersibility, and does not affect the next step, has been urgently required.

### DISCLOSURE OF INVENTION

First to Fourth Aspects of Present Invention

The present inventors have found that mixing an electrolyte characterized by a high level of ion conductivity and a high level of solubility, for example, with a curable monomer followed by curing can realize the provision of a composition, which can impart a high level of antistatic properties and hard coat properties, a (optical) single layer material, a (optical) member, or a (optical) laminate. Thus, according to the present invention, there is provided an optically functional material which simultaneously has both a high level of antistatic properties (electrical conductivity) and hard coat properties.

According to a first aspect of the present invention, there is provided

a composition which can simultaneously realize antistatic properties and hard coat properties,

the composition comprising an electrolyte having antistatic properties and a monomer, an oligomer, or a prepolymer having hard coat properties.

According to another aspect of the present invention, there is provided
a member which can simultaneously realize antistatic properties and hard coat properties,

the member comprising an electrolyte having antistatic properties and a monomer, an oligomer, or a prepolymer having hard coat properties.

Second Aspect of Present Invention

According to a second aspect of the present invention, there is provided

a member which can simultaneously realize antistatic properties and hard coat properties,

the member comprising an electrolyte having antistatic properties and a monomer, an oligomer, or a prepolymer having hard coat properties,

the electrolyte is dispersed in the monomer, oligomer, or prepolymer, and
the dispersed electrolyte is present in a tightly bound state in a three-dimensional network structure produced by curing the monomer, oligomer, or prepolymer by heat and/or an ionizing radiation.

In the second aspect of the present invention, the electrolyte is dispersed and tightly bound with a three-dimensional network structure, and, thus, a member having even and high electrical conductivity can be provided.

Third Aspect of Present Invention

According to a third aspect of the present invention, there is provided

a single layer material which can simultaneously realize antistatic properties and hard coat properties,
the single layer material comprising an electrolyte having antistatic properties and a monomer, an oligomer, or a prepolymer having hard coat properties.

Fourth Aspect of Present Invention

According to a fourth aspect of the present invention, there is provided

a laminate comprising a base material and an optical function layer provided on the base material, wherein

the optical function layer is a single layer which can simultaneously realize antistatic properties and hard coat properties and comprises an electrolyte having antistatic properties and a monomer, an oligomer, or a prepolymer having hard coat properties.

The first to fourth aspects of the present invention can provide a member comprising an electrolyte dispersed and held within a cured product of a monomer or the like, which simultaneously has both hard coat properties and antistatic properties. This can eliminate the need to provide an optical member comprising at least two layers, i.e., a hard coat layer and an antistatic layer, stacked on top of each other, and, thus, a composition, a (optical) single layer material, a (optical) member, or a (optical) laminate, which can effectively eliminate optical problems caused by stacking a plurality of layers on top of each other, can simplify the production process, and exhibit various optical properties, can be provided at low cost.

In particular, the first to fourth aspects of the present invention can provide a composition, a (optical) single layer material, a (optical) member, or a (optical) laminate, which simultaneously has antistatic properties and hard coat properties. This can eliminate the need to provide a (optical) member comprising at least two layers, i.e., a hard coat layer and an antistatic layer, stacked on top of each other, and, thus, a composition, a (optical) single layer material, a (optical) member, or a (optical) laminate, which can effectively eliminate optical problems caused by stacking a plurality of layers on top of each other, can simplify the production process, and exhibit various optical properties, can be provided at low cost.

In particular, the first to fourth aspects of the present invention can provide a composition, a (optical) single layer material, a (optical) member, or a (optical) laminate, which has excellent lightfastness and moist heat resistance, does not cause a variation in surface electrical resistance and total light transmittance upon a change in environment, and can simultaneously satisfy hard coat properties and antistatic properties.

Fifth to Seventh Aspects of Present Invention

The present inventors have found that the adoption of an ionic liquid, which is liquid at room temperature, as an electrolyte can realize the provision of an antistatic composition, an antistatic (optical) single layer material, an antistatic (optical) member, or an antistatic (optical) laminate, which can realize a high level of solubility and a high level of compatibility with various resins and solvents, and can realize a high level of ion conductivity. Accordingly, the present invention can realize an optically functional material having a high level of antistatic properties (electrical conductivity).

Fifth Aspect of Present Invention

According to a fifth aspect of the present invention, there is provided

an antistatic composition comprising an electrolyte (preferably an ionic liquid) having antistatic properties and a resin.

According to another aspect of the present invention, there is provided

an antistatic member comprising an electrolyte (preferably an ionic liquid) having antistatic properties and a resin.

Sixth Aspect of Present Invention

According to a sixth aspect of the present invention, there is provided

an antistatic single layer material comprising an electrolyte (preferably an ionic liquid) having antistatic properties and a resin.

Seventh Aspect of Present Invention

According to a seventh aspect of the present invention, there is provided
a laminate comprising a base material and an optical function layer provided on the base material, wherein

the optical function layer has a single layer structure having antistatic properties and comprises an electrolyte having antistatic properties (preferably an ionic liquid) and a resin.

In the fifth to seventh aspects according to the present invention, the use of a specific antistatic material can realize a high level of electrical conductivity on the order of less than 1×10¹⁰ Ω/cm² without the need to select specific resins, solvents and the like and, at the same time, can allow the next step to be easily carried out without posing any problem such as separation of fine particles. In particular, the fifth to seventh aspects of the present invention can provide a (optical) single layer material, a (optical) member, or a (optical) laminate, which has excellent lightfastness and moist heat resistance, does not cause a variation in surface resistance values and total light transmittance upon a change in environment, and has antistatic properties.

### BEST MODE FOR CARRYING OUT THE INVENTION

### I. Definition

First to Seventh Aspects of Present Invention

Antistatic Properties (Electrical Conductivity)

The antistatic properties can be expressed in terms of surface electrical resistance value (Ω/cm²). The electrical resistance value (Ω/cm²) can be measured with a surface resistivity measuring apparatus.

Hard Coat Properties

The hard coat properties are measured by a pencil hardness test as specified in JIS 5600-5-4 (1999).

Surface Haze (Hs), Internal Haze (Hi), and Overall Haze (Ha)

The term “surface haze (Hs)” as used herein is determined as follows. The haze of the member, single layer material, laminate and the like according to the present invention refers to as “overall haze (Ha).” When these materials have a flattened surface, they do not have any haze derived from surface concavoconvexes but have only an internal haze. This haze refers to as an “internal haze (Hi).” The value obtained by subtracting the “internal haze (Hi)” from the “overall haze (Ha)” is refers to as a haze attributable only to surface concavoconvexes, that is, a surface haze (Hs).

Haze Value

The haze value may be measured according to JIS K 7136. A reflection-transmittance meter HM-150 (Murakami Color Research Laboratory) may be mentioned as an instrument used for the measurement. The haze is measured in such a sate that the coated surface faces a light source.

Average Spacing of Profile Irregularities (Concavoconvexes) Sm (μm), Average Inclination Angle θa (degree), Rz (μm), and Ra (μm)

The surface of the member, single layer material, laminate and the like has a concavoconvex shape (for example, an anti-dazzling layer), the concavoconvexes are defined by the following numerical values. Sm (μm) represents the average spacing of profile irregularities (concavoconvexes), θa (degree) represents the average inclination angle of the concavoconvex part, Rz (μm) represents the ten-point average roughness, and Ra (μm) represents the arithmetical average roughness. These may be defined as described in an instruction manual (revised on Jul. 20, 1995) of a surface roughness measuring device (model: SE-3400, manufactured by Kosaka Laboratory Ltd.) in conformity with JIS B 0601 1994. θa (degree) represents the angle mode, and, when the inclination is Δa in terms of aspect ratio, Δa=tan θa is established (sum of differences (corresponding to the height of each convex) between the minimum part and the maximum part in each concavoconvex/reference length). The “reference length” is the same as in the following measuring condition 1 and is the measured length (cut-off value λc) which has been actually measured with a tracer by SE-3400.

In the measurement of the parameters (Sm, θa, Rz, and Ra) representing the surface roughness of the member, single layer material, laminate and the like according to the present invention, for example, the above surface roughness measuring device is provided. According to JIS B 0601 1994, the reference length and the evaluation length are selected, and the measurement is carried out under measuring conditions for the surface roughness measuring device. In the present invention, the measurement is carried out under the following conditions.

1) Tracer in surface roughness detector:
Model/SE2555N (standard 2 μm), manufactured by Kosaka Laboratory Ltd.
(radius of curvature in tip 2 μm/apex angle: 90 degrees/material: diamond)

2) Measuring conditions for surface roughness measuring device:
Reference length (cut-off value of roughness curve λc): 0.8 mm
Evaluation length (reference length (cut-off value λc) ×5): 4.0 mm
Feed speed of tracer: 0.1 mm/sec

Method for Measuring Layer Thickness

The cross section of the member is subjected to transmission observation under a confocal laser microscope (LeicaTCS-NT, manufactured by Leica: magnification “300 to 1000 times”) to determine whether or not the interface is present, and the results are evaluated according to the following criteria. Specifically, in order to provide a halation-free sharp image, a wet objective lens is used in a confocal laser microscope, and about 2 ml of an oil having a refractive index of 1.518 is placed on an optical laminate, followed by observation to determine the presence or absence of the interface. The oil is used to allow the air layer between the objective lens and the member to disappear.

Measurement Procedure

1: The average thickness of the layer was measured by observation under a laser microscope.

2: The measurement was carried out under the above conditions.

3: For one image plane, the layer thickness from the base material to the maximum profile peak (convex) part in the concavoconvexes was measured for one point, and the layer thickness from the base material to the minimum valley (concave) part in the concavoconvexes was measured for one point. That is, the layer thickness is measured for two points in total for one image plane. This measurement was carried out for five image planes, that is, 10 points in total, and the average value is determined. This value was regarded as the total thickness of the layer.

Lightfastness

Regarding the lightfastness, in the single layer material, laminate, or member, the ratio between surface resistivity R1 before a 50-hr lightfastness test and surface resistivity R2 after the 50-hr lightfastness test under conditions of black panel temperature 63±3° C. and humidity 40±10% RH, that is, “R2/R1,” is 10 or less. In the present invention, the R2/R1 is preferably approximately 10 to 1.

Resistance to Moist Heat

Regarding the resistance to moist heat, in the single layer material, laminate, or member, the ratio between surface resistivity R1′ before a 500-hr lightfastness test and surface resistivity R2′ after the 500-hr lightfastness test under high-temperature and high-humidity conditions of 80° C. and humidity 90%, that is, “R2′/R1′,” is 10 or less. In the present invention, the R2′/R1′ is preferably approximately 10 to 1.

### First Aspect of Present Invention

### I. Composition

Electrolyte

The term “electrolyte” as used herein refers to a conductive material which, in the present invention, is preferably a liquid at room temperature. In a preferred aspect of the present invention, the so-called “ionic liquid” is preferably mentioned as the electrolyte. The term “ionic liquid” is in a liquid state at room temperature or in a relatively low temperature region. Further, the “ionic liquid” is also characterized, for example, by having a high level of ion conductivity, a high level of thermal stability, and a relatively low level of viscosity, and further having substantially no vapor pressure, neither inflammability nor combustibility, and a broad liquid temperature range. The amount of the electrolyte added is not less than 1% by weight and not more than 50% by weight based on the total amount of the composition. Preferably, the lower limit of the amount of the electrolyte added is 5% by weight, and the upper limit of the amount of the electrolyte added is 30% by weight.

A cationic material is preferred as the ionic liquid. The cationic material is generally present in the form of a salt with an anion which is a counter ion. Specific examples of ionic liquids include cationic materials, for example, imidazolium-type, pyridium-type, pyrrolidinium-type, quaternary ammonium-type, and quaternary phosphonium-type canionic materials. These cationic materials are generally present in the form of a salt (a liquid) of these cationic materials bound to an anion as a counter ion, for example, a halogen, a triflate, tetrafluoroborate, or hexafluorophosphate. In the present invention, among the ionic liquids, imidazolium-type and pyridium-type materials and their salts are preferred.

Specific examples of imidazolium-type materials and their salts (wherein the name within double quotations represents a counter ion) include 1,3-dimethylimidazolium “chloride,” 1,3-dimethylimidazolium “dimethylphosphate,” 1-ethyl,3-methylimidazolium “chloride,” 1-ethyl,3-methylimidazolium “bromide,” 1-ethyl,3-methylimidazolium “iodide,” 1-ethyl,3-methylimidazolium “trifluoromethanesulfonate,” 1-ethyl,3-methylimidazolium “p-toluenesulfonate,” 1-ethyl,3-methylimidazolium “ethyl sulfate,” 1-ethyl,3-methylimidazolium “2-methyl(2-methoxyethoxy)ethyl sulfate,” 1-ethyl,3-methylimidazolium “dicyanamide,” 1-ethyl,3-methylimidazolium “tetrafluoroborate,” 1-ethyl,3-methylimidazolium “hexafluorophosphate,” 1-ethyl,3-methylimidazolium “bis(trifluoromethanesulfonyl)imide,” 1-methyl,3-propylimidazolium “iodide,” 1-butyl,3-methylimidazolium “chloride,” 1-butyl,3-methylimidazolium “bromide,” 1-butyl,3-methylimidazolium “iodide,” 1-butyl,3-methylimidazolium “trifluoromethanesulfonate,” 1-butyl,3-methylimidazolium “tetrafluoroborate,” 1-butyl,3-methylimidazolium “hexafluorophosphate,” 1-butyl,3-methylimidazolium “bis(trifluoromethanesulfonyl)imide,” 1-butyl,3-methylimidazolium “tetrachloroferrate,” 1-hexyl,3-methylimidazolium “chloride,” 1-hexyl,3-methylimidazolium “hexafluorophosphate,” 1-hexyl,3-methylimidazolium “tetrafluoroborate,” 1-butyl,2,3-dimethylimidazolium “chloride,” 1-butyl,2,3-dimethylimidazolium “tetrafluoroborate,” and 1-butyl,2,3-dimethylimidazolium “hexafluorophosphate.” Among them, 1-ethyl,3-methylimidazolium “trifluoromethanesulfonate” is preferred because of its high ion conductivity.

Specific examples of pyrrolidinium-type materials and their salts (wherein the name within double quotations represents a counter ion) include 1-butyl-1-methylpyrrolidinium “bis(trifluoromethanesulfonyl)imide.”

Specific examples of pyridinium-type materials and their salts (wherein the name within double quotations represents a counter ion) include 1-ethylpyridinium “chloride,” 1-ethylpyridinium “bromide,” 1-butylpyridinium “chloride,” 1-butylpyridinium “bromide,” 1-butylpyridinium “hexafluorophosphate”, 1-butyl-4-methylpyridinium “bromide”, 1-butyl-4-methylpyridinium “hexafluorophosphate”, 1-ethyl-3-methylpyridinium “ethyl sulfate”, and 1-ethyl-3-(hydroxymethyl)pyridinium “ethyl sulfate.” Among them, 1-ethyl-3-(hydroxy)methyl)pyridinium “ethyl sulfate” is preferred because of its high ion conductivity.

Monomer, Oligomer, or Prepolymer

In the present invention, monomers, oligomers, or prepolymers having hard coat properties are utilized. Preferably, they have a plurality of functional groups curable upon exposure to heat and/or an ionizing radiation. The number of the plurality of functional groups is two or more, preferably six or more. Examples of functional groups include condensable groups and reactive groups, for example, hydroxyl, acid anhydride, carboxyl, amino, imino, epoxy, glycidyl, and isocyanate groups; C2-6 alkenyl groups, for example, vinyl, propenyl, isopropenyl, butenyl, and allyl groups; C2-6 alkynyl groups, for example, ethynyl, propynyl, and butynyl groups; C2-6 alkenylidene groups, for example, vinylidene, or groups containing these polymerizable groups, for example, (meth)acryloyl groups. Among them, polymerizable groups are preferred. The amount of the monomer, oligomer, or prepolymer added is not less than 50% by weight and not more than 99% by weight based on the total amount of the composition. Preferably, the lower limit of the addition amount is 70% by weight, and the upper limit of the addition amount is 95% by weight.

Specific examples of monomers, oligomers, or prepolymers containing polymerizable groups include compounds containing radical polymerizable functional groups such as (meth)acrylate group, for example, (meth)acrylate monomers. More specific examples thereof include relatively low-molecular weight polyester monomers, polyether monomers, acryl monomers, epoxy monomers, uerethane monomers, alkyd monomers, spiroacetal monomers, polybutadiene monomers, polythiolpolyene monomers, and (meth)acrylates of polyfunctional compounds such as polyhydric alcohols. Still more specific examples thereof include ethyl (meth)acrylate, ethylhexyl (meth)acrylate, trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate. The term “(meth)acrylate” refers to acrylate or methacrylate.

Examples of compounds other than the (meth)acrylate compounds include monofunctional or polyfunctional monomers, for example, styrene, methylstyrene, and N-vinylpyrrolidone, or compounds containing cation polymerizable functional groups, for example, monomers such as bisphenol-type epoxy compounds, novolak-type epoxy compounds, aromatic vinyl ethers, and aliphatic vinyl ethers.

Further examples thereof include polyfunctional monomers, for example, ethylene glycol di(meth)acrylate, 1,4-dicyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, and pentaerythritol hexa(meth)acrylate, and cyclic ether bond-containing oligomers, for example, epoxy oligomers such as bisphenol-type epoxy resins and novolak-type epoxy compounds and vinyl ether oligomers such as fatty acid-type vinyl ethers and aromatic vinyl ethers.

Monomers, oligomers, and prepolymers of heat curing resins include monomers or oligomers containing heat curable groups such as alkoxy, hydroxyl, carboxyl, amino, epoxy, isocyanate, aziridine, oxazoline, aldehyde, carbonyl, hydrazine, vinyl, cyano, methylol, and active methylene groups. The heat curable group may be a functional group like a blocked isocyanate which comprises a blocking agent bonded to a reactive functional group and, upon heating, allows to a decomposition reaction of the blocking agent to proceed to develop polymerizability or crosslinkability. Organometal compounds, for example, organosilicon compounds (silicon alkoxides or silane coupling agents), organotitanium compounds (titanate coupling agents), or organoaluminum compounds, which are generally used as coupling agents, may also be used as the monomer of the heat curing resin. Organosilicon compounds include methyltrimethoxysilane, methyltriethoxysilane, methyltrimethoxyethoxysilane, 3-glycidoxypropyltrimethoxysilane, 3-aminopropyltrimethoxysilane. Among these oganosilicon compounds, reactive group-containing organosilicon compounds are likely to undergo a curing reaction with other monomers or oligomers to form a strong bond and thus can contribute to improve the strength of the resultant electroconductive resin cured product. Organotitanium compounds include tetramethoxytitanium and tetraethoxytitanium.

Resin

The monomer, oligomer or prepolymer according to the present invention may comprises a resin. Resins usable herein may be classified into three types of resins, that is, ionizing radiation curing resins which are curable upon exposure to an ionizing radiation (for example, ultraviolet light or electron beams), mixtures of ionizing radiation curing resins with solvent drying-type resins, or heat curing resins. Preferred are ionizing radiation curing resins. In a preferred embodiment of the present invention, resins comprising at least an ionizing radiation curing resin and a heat curing resin may be used.

Specific examples of ionizing radiation curing resins include compounds containing a radical polymerizable functional group such as an (meth)acrylate group, for example, (meth)acrylate oligomers, prepolymers, or monomers. Specific examples thereof include oligomers or prepolymers of relatively low-molecular weight polyester resins, polyether resins, acrylic resins, epoxy resins, urethane resins, alkyd resins, spiroacetal resins, polybutadiene resins, and polythiol polyene resins and (meth)acrylic esters of polyfunctional compounds such as polyhydric alcohols. Specific examples of monomers include ethyl (meth)acrylate, ethylhexyl (meth)acrylate, trimethylolpropane tri(meth)acrylate, hexanediol (meth)acrylate, tripropylene glycol di(meth)acrylate, diethylene glycol di (meth)acrylate, pentaerythritol tri (meth)acrylate, dipentaerythritol hexa(meth)acrylate, 1,6-hexanediol di(meth)acrylate, and neopentyl glycol di(meth)acrylate. The term “(meth)acrylate” means acrylate or methacrylate.

Examples of compounds other than the (meth)acrylate compound include monofunctional or polyfunctional monomers such as styrene, methylstyrene, and N-vinylpyrrolidone, or cation polymerizable functional group-containing compounds, for example, oligomers and prepolymers of bisphenol-type epoxy compounds, novolak-type epoxy compounds, aromatic vinyl ethers, aliphatic vinyl ethers and the like.

For example, acetophenones, benzophenones, Michler's benzoyl benzoate, α-amyloxime ester, tetramethylthiuram monosulfide, and thioxanthones may be applied as the photopolymerization initiator to be added to the ionizing radiation curing resin composition. If necessary, photosensitizers and photopolymerization accelerators are added to the ionizing radiation curing resin composition. Conventional photosensitizers and photopolymerization accelerators may be used as the photosensitizer and photopolymerization accelerator, and examples thereof include benzoin compounds such as benzoin, benzoin methyl ether, benzoin ethyl ether, benzoin isopropyl ether, α-methylbenzoin, and α-phenylbenzoin; anthraquinone compounds such as anthraquinone and methylanthraquinone; benzyl; diacetyl; phenyl ketone compounds such as acetophenone and benzophenone; sulfide compounds such as diphenyl disulfide and tetramethylthiuram sulfide; α-chloromethyl naphthalene; anthracene; halogenated hydrocarbons such as hexachlorobutadiene and pentachlorobutadiene; thioxanthone; n-butylamine; triethylamine; and tri-n-butylphosphine. Benzophenon or thioxanthone photosensitizers are preferred when the acetophenone photopolymerization initiators are used.

The solvent drying-type resin used as a mixture with the ionizing radiation curing resin is mainly a thermoplastic resin. Commonly exemplified thermoplastic resins are usable. Coating defects of the coated face can be effectively prevented by adding the solvent drying-type resin. Specific examples of preferred thermoplastic resins include cellulosic resins, for example, nitrocellulose, acetylcellulose, cellulose acetate propionate, and ethylhydroxyethylcellulose. Further, in the present invention, in addition to the above-described resins, vinyl resins such as vinyl acetate and its copolymers, vinyl chloride and its copolymers, and vinylidene chloride and its copolymers, acetal resins such as polyvinylformal and polyvinylbutyral, acrylic resins such as acrylic resin and its copolymers and methacrylic resin and its copolymers, polystyrene resins, polyamide resins, and polycarbonate resins may be mentioned.

Specific examples of heat curing resins include phenolic resins, urea resins, diallyl phthalate resins, melanin resins, guanamine resins, unsaturated polyester resins, polyurethane resins, epoxy resins, aminoalkyd resins, melamine-urea cocondensed resins, silicone resins, and polysiloxane resins. When the heat curing resin is used, if necessary, for example, curing agents such as crosslinking agents and polymerization initiators, polymerization accelerators, solvents, and viscosity modifiers may be further added.

Other Components

The composition according to the present invention comprises the above components as indispensable components. Components, which can exhibit other functions, especially other optical functions, however, may also be added. This can realize the provision of a composition which simultaneously exhibit other properties (optical properties) other than the antistatic properties and hard coat properties. This member can exhibit as a single cured product various optical properties. In the present invention, the composition may further comprise one material or a mixture of two or more materials selected from the group consisting of anti-dazzling agents, refractive index regulating agents, antifouling agents (including water repellents, oil repellents, and fingerprint deposition preventive agents), hardness enhancing agents, and hardness regulating agents.

1. Anti-Dazzling Agent

In the present invention, any anti-dazzling agent may be used so far as it has anti-dazzling properties. Among them, anti-dazzling agents formed of fine particles are preferred. The amount of anti-dazzling agents added is not less than 5% by weight and not more than 40% by weight based on the total amount of the composition of the present invention. Preferably, the lower limit of the amount of the anti-dazzling agent added is 10% by weight, and the upper limit of the amount of the anti-dazzling agent added is 30% by weight.

Difference n in Refractive Index

In the present invention, the difference n in refractive index between the monomer and the fine particles is preferably not more than 0.20. More specifically, the refractive index difference n is not less than 0.03 and not more than 0.20. Preferably, the lower limit of the refractive index difference n is 0.05, more preferably 0.09, and the upper limit of the refractive index difference n is 0.18, more preferably 0.12. When the difference n in refractive index between the monomer and the fine particles falls within the above-defined range, the internal haze of the optical laminate can be imparted and uneven image in LCDs and the like and scintillation caused upon the transmission of light such as backlight transmitted through the optical laminate having a concavoconvex shape on its surface from its backside can be effectively prevented. The term “scintillation” as used herein means a phenomenon seen by the eye as twinkling flickering.

On the other hand, in another preferred embodiment of the present invention, the difference n in refractive index between the monomer and the fine particles is more than 0 and less than 0.03. The lower limit of the refractive index difference n is preferably 0.001, more preferably 0.005, and the upper limit of the refractive index difference n is preferably 0.02, more preferably 0.01. When the difference n in refractive index between the monomer and the fine particles is in the above-defined range, a high contrast can be realized.

In the present invention, the difference n in refractive index between the monomer and the fine particles is defined in the above two numerical range levels. This is not technically contradictory, because the above two numerical range levels are necessary for realizing respective desired optical properties as the optical laminate, particularly on which the optical laminate of the present invention is mounted, for realizing optical properties optimal for modes in individual liquid crystal, PDP, CRT or other panels.

Fine Particles

The fine particles may be in a spherical, for example, truly spherical, elliptical form, or irregular shape. The fine particles may be aggregation-type fine particles. In the present invention, the average particle diameter R (μm) of the fine particles is not less than 0.3 μm and not more than 20 μm. Preferably, the upper limit of the average particle diameter R is 15.0 μm, more preferably 10 μm, still more preferably 7.0 μm, and the lower limit of the average particle diameter R is 1.0 μm, more preferably 1.5 μm. When the average particle diameter R of the fine particles is in the above-defined range, advantageously, a proper concavoconvex shape can be formed. The “average particle diameter” is an average particle diameter when the fine particles are monodisperse particles (particles having a single shape). When the particles have a broad particle size distribution, the diameter of particles which occupy the largest proportion of the particles as determined by particle size distribution measurement is regarded as the average particle diameter. The particle diameter of the fine particles may be mainly measured by a Coulter counter method. Further, in addition to the above method, laser diffractometry and SEM photographing may also be adopted.

In the present invention, when monodisperse particles are used, not less than 80% (preferably not less than 90%) of the whole fine particles is preferably accounted for by fine particles having an average particle diameter distribution of R±1.0 μm, preferably R±0.5 μm, more preferably R±0.3 μm. When the average particle diameter distribution of the fine particles falls within the above-defined range, the evenness of the concavoconvex shape can be rendered good and, at the same time, scintillation and the like can be effectively prevented. Further, the fine particle system may be such that the above fine particles are used as first fine particles, and a plurality of types of fine particles having an average particle diameter different from the first fine particles, for example, second fine particles, third fine particles or nth fine particles, wherein n is a natural number, are further included. For example, for small first fine particles of which the average particle diameter R (μm) is approximately 3.5 μm, a concavoconvex layer can be efficiently formed using fine particles having a particle size distribution with the average particle diameter being 1.5 μm rather than monodisperse fine particles. When a plurality of types of fine particles different from each other in average particle diameter are contained, the average particle diameter of each of the second, third and nth fine particles is preferably in the same average particle diameter range as the above fine particles (first fine particles). When the fine particles used have a broad particle size distribution, it would be understood to a person having an ordinary skill in the art that the average particle size distribution is not as described above.

Aggregation-Type Fine Particles

In the present invention, aggregation-type fine particles among the fine particles may be used. The aggregation-type fine particles may be identical fine particles, or alternatively may be a plurality of types of fine particles different from each other in average particle diameter. Accordingly, when a plurality of types of aggregated fine particles are used, the fine particle system may comprise (aggregated) first fine particles, and (aggregated) second fine particles, (aggregated) third fine particles, or (aggregated) nth fine particles, wherein n is a natural number, which are different from the first fine particles in average particle diameter. When the (aggregated) second fine particles, (aggregated) third fine particles, or (aggregated) nth fine particles are used, preferably, these particles as such or the aggregated part as such do not exhibit anti-dazzling properties. In the case of the aggregation-type fine particles, preferably, the secondary particle diameter falls within the above average particle diameter range.

The fine particles (first, second, third, and nth fine particles) are not particularly limited. They may be of inorganic type and organic type and are preferably transparent. Specific examples of fine particles formed of an organic material include plastic polymer beads. Plastic beads include styrene beads (refractive index 1.60), melamine beads (refractive index 1.57), acrylic beads (refractive index 1.49 to 1.535), acryl-styrene beads (refractive index 1.54 to 1.58), benzoguanamine-formaldehyde beads, polycarbonate beads, and polyethylene beads. Preferably, the plastic bead has a hydrophobic group on its surface, and, for example, styrene beads may be mentioned. For example, spherical silica and amorphous silica may be mentioned as the inorganic fine particle.

Silica beads having a particle diameter of 0.3 to 5 μm and having good dispersibility are preferred as the amorphous silica. The content of the amorphous silica is preferably 0.5 to 30 parts by mass based on the binder monomer. In this case, the increase in viscosity of the composition of the present invention can be suppressed to render the dispersibility of the amorphous silica good. Further, in the present invention, the surface of the particles may be treated with an organic material or the like. The treatment of the surface of the particles with an organic material is preferably hydrophobilization.

The organic material treatment may be carried out by any of a chemical method in which a compound is chemically bonded to the surface of the bead, and a physical method in which a compound is impregnated into voids or the like present in the composition constituting the bead without chemical bonding to the bead surface. In general, a chemical treatment method utilizing an active group present on silica surface, for example, hydroxyl group or silanol group, is preferably used from the viewpoint of treatment efficiency.

Specific examples of compounds usable for the treatment include silane-type, siloxane-type, and silazane-type materials highly reactive with the active group, for example, straight chain alkyl monosubstituted silicone materials such as methyltrichlorosilane, branched alkyl monosubstituted silicone materials, or polysubstituted straight chain alkylsilicone compounds and polysubstituted branched chain alkylsilicone compounds such as di-n-butyldichlorosilane and ethyldimethylchlorosilane. Likewise, straight chain alkyl group or branched alkyl group monosubstituted or polysubstituted siloxane materials and silazane materials can also be effectively used.

If necessary, the end or intermediate site of the alkyl chain may have a hetero atom, an unsaturated bond group, a cyclic bond group, an aromatic functional group or other group. In these compounds, the alkyl group contained therein is hydrophobic. Accordingly, the surface of the object material to be treated can easily be converted from a hydrophilic property to a hydrophobic property. As a result, even in the case of polymer materials having poor affinity in the untreated state, a high level of affinity can be realized.

When a plurality of types of fine particles are used as a mixture, fine particles different from each other in average particle diameter and, further, some of or all of material and shape are properly selected and used while taking the functions of the plurality of types of fine particles into consideration as described above.

Regarding the plurality of types of fine particles different from each other in material, the use of two or more types of fine particles different from each other in refractive index is preferred. When these fine particles are mixed together, the refractive index of the fine particles may be regarded as an average value dependent upon the refractive index of each type of fine particles and the ratio of use of each type of fine particles. The regulation of the mixing ratio of the fine particles can realize detailed refractive index setting. In this case, the control of the refractive index is easier than the case where a single type of fine particles is used, and, consequently, various refractive index designs are possible. For example, when two types of fine particles different from each other in refractive index are used, a relationship of the average particle diameter R1 of the first fine particles>the average particle diameter R2 of the second fine particles is preferably satisfied. Alternatively, in this case, the two types of fine particles may be identical to each other in particle diameter. In this case, the ratio between the first fine particles and the second fine particles can be freely selected. This facilitates the design of light diffusing properties. In order to render the particle diameter of the first fine particles and the particle diameter of the second fine particles identical to each other, the use of organic fine particles which can easily provide monodisperse particles is preferred. The lower the level of variation of the particle diameter, advantageously the lower the level of variation in anti-dazzling properties and internal scattering properties and the easier the optical property design. Means for further improving monodispersibility include pneumatic classification and wet filtration classification by a filter.

2. Refractive Index Regulating Agent

The refractive index regulating agent may be added to regulate the optical properties of the composition according to the present invention. Examples of such refractive index regulating agents include low-refractive index agents, medium-refractive index agents, and high-refractive index agents.

The amount of the refractive index regulating agent added is not less than 5% by weight and not more than 40% by weight based on the total amount of the composition of the present invention. Preferably, the lower limit of the amount of the refractive index regulating agent added is 10% by weight, and the upper limit of the amount of the refractive index regulating agent added is 30% by weight. Further, in the present invention, the amount of the low-refractive index agent added is not limited to the above amount range and is preferably not more than 250% by weight based on the total amount of the composition.

1) Low-Refractive Index Agent

Preferred low-refractive index agents include low-refractive index inorganic ultrafine particles such as silica and magnesium fluoride (all types of fine particles such as porous and hollow fine particles), and fluoromonomers which are low-refractive index resins. Polymerizable compounds containing a fluorine atom at least in their molecule, or polymers thereof are usable as the fluoromonomer. The polymerizable compound is not particularly limited. However, for example, those containing a curing reactive group such as a functional group curable by an ionizing radiation or a heat curable polar group are preferred. Further, compounds simultaneously having these reactive groups are also possible. Unlike the polymerizable compounds, the polymer does not have the above reactive groups at all.

In a preferred embodiment of the present invention, the utilization of “void-containing fine particles” as a low-refractive index agent is preferred. “Void-containing fine particles” can lower the refractive index while maintaining the strength of the member formed using the composition according to the present invention. In the present invention, the term “void-containing fine particle” refers to a fine particle which has a structure comprising air filled into the inside of the fine particle and/or an air-containing porous structure and has such a property that the refractive index is lowered in reverse proportion to the proportion of air which occupies the fine particle as compared with the refractive index of the original fine particle. Further, such a fine particle which can form a nanoporous structure in at least a part of the inside and/or surface of the coating film by utilizing the form, structure, aggregated state, and dispersed state of the fine particle within the coating film, is also embraced in the present invention.

Specific examples of preferred void-containing inorganic fine particles are silica fine particles prepared by a technique disclosed in Japanese Patent Laid-Open No. 233611/2001. Other examples thereof include silica fine particles produced by a process described, for example, in Japanese Patent Laid-Open No. 133105/1995, No. 79616/2002, and No. 106714/2006. The void-containing silica fine particles can easily produced. Further, the hardness of the void-containing silica fine particles is high. Therefore, when a mixture of the void-containing silica fine particles with a binder is used, the member has improved strength and, at the same time, the refractive index can be regulated to a range of approximately 1.20 to 1.45. Hollow polymer fine particles produced by using a technique disclosed in Japanese Patent Laid-Open No. 80503/2002 are a specific example of preferred void-containing organic fine particles.

Fine particles which can form a nanoporous structure in at least a part of the inside and/or surface of the coating film include, in addition to the above silica fine particles, sustained release materials, which have been produced for increasing the specific surface area and adsorb various chemical substances on a packing column and the porous part of the surface, porous fine particles used for catalyst fixation purposes, or dispersions or aggregates of hollow fine particles to be incorporated in heat insulating materials or low-dielectric materials. Specific examples of such fine particles include commercially available products, for example, aggregates of porous silica fine particles selected from tradename Nipsil and tradename Nipgel manufactured by Nippon Silica Industrial Co., Ltd. and colloidal silica UP series (tradename), manufactured by Nissan Chemical Industries Ltd., having such a structure that silica fine particles have been connected to one another in a chain form, and fine particles in a preferred particle diameter range specified in the present invention may be selected from the above fine particles.

The average particle diameter of the “void-containing fine particles” is not less than 5 nm and not more than 300 nm. Preferably, the lower limit of the average particle diameter is 8 nm, and the upper limit of the average particle diameter is 100 nm. More preferably, the lower limit of the average particle diameter is 10 nm, and the upper limit of the average particle diameter is 80 nm. When the average diameter of the fine particles is in the above-defined range, excellent transparency can be imparted to the member formed using the composition according to the present invention.

2) High-Refractive Index Agent/Medium-Refractive Index Agent

The high-refractive index agent and the medium-refractive index agent may be added to improve antireflective properties. The refractive index of the high-refractive index agent and medium-refractive index agent may be set in a range of 1.55 to 2.00. The medium-refractive index agent has a refractive index in the range of 1.55 to 1.80, and the refractive index of the high-refractive index agent is in the range of 1.65 to 2.00.

These refractive index agents include fine particles, and specific examples thereof (the numerical value within the parentheses being a refractive index) include zinc oxide (1.90), titania (2.3 to 2.7), ceria (1.95), tin-doped indium oxide (1.95), antimony-doped tin oxide (1.80), yttria (1.87), and zirconia (2.0).

Antifouling Agent

A antifouling agent is mainly used to prevent the contamination of the outermost surface of the member formed using the composition according to the present invention and further can impart scratch resistance to the member. The amount of the antifouling agent added is not less than 0.01% by weight and not more than 10% by weight based on the total amount of the composition of the present invention. Preferably, the lower limit of the amount of the antifouling agent added is 0.1% by weight, and the upper limit of the amount of the antifouling agent added is 1% by weight.

Specific examples of effective antifouling agents include additives which can develop water repellency, oil repellency, and fingerprint wiping-off properties. More specific examples of antifouling agents include fluorocompounds and silicon compounds or mixtures of these compounds. More specific examples thereof include fluoroalkyl group-containing silane coupling agents such as 2-perfluorooctylethyltriaminosilane. Among them, amino group-containing compounds are particularly preferred.

In a preferred embodiment of the present invention, organic fine particles and inorganic fine particles may be contained for regulating the fluidity and hardness. The amount of the fluidity regulating agent added is not less than 0.01% by weight and not more than 10% by weight based on the total amount of the composition of the present invention. Preferably, the lower limit of the amount of the fluidity regulating agent added is 0.1% by weight, and the upper limit of the amount of the fluidity regulating agent added is 1% by weight.

Specific examples of organic fine particles and inorganic fine particles include colloidal silica and polymer latexes having a core-shell structure. The term “colloidal silica” as used herein means a colloidal solution containing silica particles in a colloid state dispersed in water or an organic solvent. The particle diameter (diameter) of the colloidal silica is preferably approximately 1 to 50 nm which is on an ultrafine particle size level. The particle diameter of the colloidal silica in the present invention is the average particle diameter as measured by a BET method. The average particle diameter is specifically determined by measuring the surface area by the BET method and calculating the average particle diameter based on the assumption that the particles are truly spherical.

The colloidal silica is known, and commercially available products thereof include, for example, “methanol silica sol,” “MA-ST-M,” “IPA-ST,” “EG-ST,” “EG-ST-ZL,” “NPC-ST,” “DMAC-ST,” “MEK,” “XBA-ST,” and “MIBK-ST” (all of which are tradenames of products manufactured by Nissan Chemical Industries Ltd.), “OSCAL1132,” “OSCAL1232,” “OSCAL1332,” “OSCAL1432,” “OSCAL1532,” “OSCAL1632,” and “OSCAL1132” (all of which are tradenames of products manufactured by Catalysts and Chemicals Industries Co., Ltd.).

Solvent

Any solvent may be used so far as it can homogeneously dissolve at least solid matter (a plurality of polymers and curable resin precursor, a reaction initiator, and other additives). Such solvents include, for example, ketones, for example, acetone, methyl ethyl ketone, methyl isobutyl ketone, and cyclohexanone; ethers, for example, dioxane and tetrahydrofuran; aliphatic hydrocarbons, for example, hexane; alicyclic hydrocarbons, for example, cyclohexane; aromatic hydrocarbons, for example, toluene and xylene; halo carbon, for example, dichloromethane and dichloroethane; esters, for example, methyl acetate, ethyl acetate, and butyl acetate; water; alcohols, for example, ethanol, isopropanol, butanol, and cyclohexanol; cellosolves, for example, methylcellosolve and ethylcellosolve; cellosolve acetates; sulfoxides, for example, dimethylsulfoxide; and amides, for example, dimethylformamide and dimethylacetamide. A mixture solvent composed of two or more of these solvents may also be used. Preferred are ketones and esters.

### II. Property and Use of Composition

1. Properties

The member produced by curing the composition according to the present invention, when formed, for example, as a film, a thin film, or a thin layer, the thickness is not less than 0.1 μm and not more than 10 μm, preferably not less than 1 μm and not more than 5 μm. This member has a high level of electrical conductivity on the order of less than 10¹⁰ Ω/cm², preferably on the order of 10⁸ Ω/cm² to 10⁹ Ω/cm². In particular, the electrical conductivity can easily be realized in the above layer thickness range. The hard coat properties of the cured antistatic member are “H” or higher, preferably “2H” or higher, as measured in a pencil hardness test specified in JIS 5600-5-4 (1999).

Anti-Dazzling Properties

When a member is formed using the composition to which an anti-dazzling agent has been added, a concavoconvex shape can be formed on the outermost surface of the member. Accordingly, in the present invention, preferably, the concavoconvex shape has the following properties.

1) Haze Value

The member, single layer material, and laminate formed using the composition to which the anti-dazzling agent has been added, satisfy all of the following numerical value requirements wherein Ha represents the whole haze value of the member, single layer material, or laminate; Hi represents the internal haze value of the member, single layer material, or laminate; and Hs represents the surface haze value of the member, single layer material, or laminate.

Ha is not less than 0.5% and less than 90%. Preferably, the lower limit of Ha is 1.5%, more preferably 6%, and the upper limit of Ha is 50%, more preferably 30%.

Hi is not less than 0.1% and not more than 80%. Preferably, the lower limit of Hi is 3.5%, more preferably 5%, and the upper limit of Hi is preferably 40%, more preferably 25%.

In a preferred embodiment of the present invention, Hs is not less than 0.5% and not more than 40%. Preferably, the lower limit of Hs is 0.8%, and the upper limit of Hs is 25%.

2) Sm, θa, Rz, and Ra

The member, single layer material, and laminate formed using the composition to which the anti-dazzling agent has been added, satisfy all of the following numerical value requirements wherein Sm represents the average spacing of concavoconvexes or profile irregularities in the anti-dazzling layer; θa represents the average inclination angle of the concavoconvex part; Rz represents the average roughness of the concavoconvexes; and Ra represents the arithmetical mean roughness.

Sm is not less than 40 μm and not more than 500 μm. Preferably, the lower limit of Sm is 80 μm, and the upper limit of Sm is 350 μm.

θa is not less than 0.1 degree and not more than 5 degrees. Preferably, the lower limit of θa is 0.3 degree, and the upper limit of θa is 2 degree.

Rz is more than 0.3 μm and not more than 3 μm. Preferably, the lower limit of Rz is 0.4 μm, and the upper limit of Rz is 2 μm.

Ra is more than 0.1 μm and not more than 0.5 μm. Preferably, the upper limit of Ra is 0.3 μm.

2. Use

The composition according to the present invention as such may be used in products where antistatic properties (electroconductivity) and hard coat properties are required. In a preferred embodiment of the present invention, there is provided a member which antistatic properties and hard coat properties can be simultaneously realized. More preferably, a member produced by curing the composition according to the present invention can be provided. Accordingly, the object can be attained by coating the composition according to the present invention as such and curing the coating. The present invention may be utilized, for example, in dust deposition preventive building materials (decorative sheets) and overcoats provided on the surface of optical disks. The antistatic and hard coating composition can be utilized, for example, in the form of inks, dried coated films, heat/light cured products, films, and molded products.

1) Member (Single Layer Material)/Ink Composition

Specifically, a member (a single layer material) having antistatic properties (electroconductivity) and hard coat properties can be produced by drying and curing the composition according to the present invention. The composition may be cured by electron beam or ultraviolet irradiation. In the case of electron beam curing, for example, electron beams having an energy of 100 KeV to 300 KeV is used. On the other hand, in the case of ultraviolet curing, for example, ultraviolet light emitted from light sources such as ultra-high-pressure mercury lamps, high-pressure mercury lamps, low-pressure mercury lamps, carbon arc lamps, xenon arc lamps, and metal halide lamps. Alternatively, the composition according to the present invention may be coated on products and members. In this case, the composition according to the present invention is coated on the surface of products and light transparent base materials by a coating method such as roll coating, Mayer bar coating, gravure coating, or die coating. After coating, the coating may be cured by the above-described drying and curing methods. Accordingly, according to still another aspect of the present invention, there is provided an ink composition using the composition according to the present invention. The composition according to the present invention as such may constitute the ink composition. Alternatively, the ink composition may be produced by adding a solvent, an additive and the like to the coating composition according to the present invention depending upon the coating method.

2) (Optical) Laminate

According to the present invention, the composition and member according to the present invention may be provided on a (light transparent) base material to produce a (optical) laminate. Thus, according to another aspect of the present invention, there are provided an optical laminate (an antireflection member), a polarizing plate using the optical laminate, and an image display device.

Base Material

In the present invention, any base material may be used so far as an optical function layer can be formed thereon. The base material may be formed of, for example, a metal, a plastic, a resin, or cloth. The shape of the base material may be, for example, a plate or a sheet, a sphere, a cube (or a rectangular parallelepiped), or a cone (or a polyangular pyramid). Further, the base material may be, for example, colorless (or colored) and transparent, opaque or semi-transparent. In the present invention, when use as an optically functional member is contemplated, the base material is preferably a light transparent base material which is a plate (or a sheet) or film form.

(Light Transparent) Base Material

The (light transparent) base material is preferably smooth and possesses excellent heat resistance and mechanical strength. Specific examples of materials usable for the light transparent base material formation include thermoplastic resins, for example, polyesters (for example, polyethylene terephthalate and polyethylene naphthalate), cellulosic resins (for example, cellulose triacetate, cellulose diacetate, and cellulose acetate butyrate), polyethersulfone, and polyolefins (polysulfone, polypropylene, and polymethylpentene), polyvinyl chloride, polyvinylacetal, polyether ketone, acrylic resins (for example, polymethyl methacrylate), polycarbonate, and polyurethane. Preferred are polyesters (polyethylene terephthalate and polyethylene naphthalate) and cellulose triacetate. Films of amorphous olefin polymers (cycloolefin polymers: COPs) having an alicyclic structure may also be mentioned as other examples of the light transparent base material. These films are base materials using norbornene polymers, monocyclic olefinic polymers, cyclic conjugated diene polymers, vinyl alicyclic hydrocarbon polymer resins and the like, and examples thereof include Zeonex and ZEONOR (norbornene resins) manufactured by Zeon Corporation, Sumilight FS-1700 manufactured by Sumitomo Bakelite Co., Ltd., ARTON (modified norbornene resin) manufactured by JSR Corporation, APL (cyclic olefin copolymer) manufactured by Mitsui Chemicals Inc., Topas (cyclic olefin copolymer) manufactured by Ticona, and Optlet OZ-1000 series (alicyclic acrylic resins) manufactured by Hitachi Chemical Co., Ltd. Further, FV series (low birefringent index and low photoelastic films) manufactured by Asahi Kasei Chemicals Corporation are also preferred as base materials alternative to triacetylcellulose.

In the present invention, preferably, these thermoplastic resins are used as a highly flexible thin film. Depending upon the form of use where curability are required, plate-like materials such as plates of these thermoplastic resins or glass plates are also usable.

The thickness of the light transparent base material is not less than 20 μm and not more than 300 μm. Preferably, the upper limit of the thickness is 200 μm, and the lower limit of the thickness is 30 μm. When the light transparent base material is a plate-like material, the thickness may be above the upper limit of the above-defined thickness range. In this case, a thickness of about 1 to 5 mm is adopted. In forming an anti-dazzling layer on the light transparent base material, the base material may be previously subjected to physical treatment such as corona discharge treatment or oxidation treatment or may be previously coated with an anchoring agent or a coating material known as a primer from the viewpoint of improving the adhesion.

3) Polarizing Plate

In another embodiment of the present invention, there is provided a polarizing plate comprising a polarizing element and a member formed using the composition according to the present invention. More specifically, there is provided a polarizing plate comprising a polarizing element and an optical laminate formed using the composition according to the present invention and provided on the surface of the polarizing element, the optical laminate being provided so that the surface of the optical laminate remote from the anti-dazzling layer faces the surface of the polarizing element. The polarizing element may comprise, for example, polyvinyl alcohol films, polyvinylformal films, polyvinylacetal films, and ethylene-vinyl acetate copolymer-type saponified films, which have been dyed with iodine or a dye and stretched. In the lamination treatment, preferably, the light transparent base material (preferably a triacetylcellulose film) is saponified from the viewpoint of increasing the adhesion or antistatic purposes.

4) Image Display Device

According to a further aspect of the present invention, there is provided an image display device. The optical laminate according to the present invention or the polarizing plate according to the present invention is provided on the surface of a display device. The image display device according to the present invention may be a non-spontaneous luminescent image display device (in which the display element per se does not emit light), for example, LCD, or a spontaneous luminescent image display device (in which the display element per se emits light), for example, PDP, FED, ELD (organic EL or inorganic EL), or CRT. The LCD which is a typical example of a non-spontaneous luminescent image display device may comprises a transmission display and a light source device for applying light to the transmission display from its backside. When the image display device according to the present invention is LCD, the optical laminate or polarizing plate according to the present invention is provided on the surface of the transmission display.

When the image display device according to the present invention is a liquid crystal display device, light emitted from the light source device is applied through the lower side of the optical laminate according to the present invention. In the liquid crystal display devices, a phase difference plate may be inserted into between the liquid crystal display element and the polarizing plate. If necessary, an adhesive layer may be provided between individual layers in the liquid crystal display device.

On the other hand, PDP, which is a spontaneous luminescent image display device, comprises a surface glass substrate having an electrode on its surface, a backside glass substrate opposed to the surface glass substrate, and a discharge gas sealed into between the surface glass substrate and the backside glass substrate. A construction may be adopted in which electrodes and very small grooves are provided on the surface of the backside glass substrate, and red, green and blue phosphor layers provided within the grooves. In this spontaneous luminescent image display device, a voltage is applied across the electrodes constituted by both the glass substrates to emit ultraviolet light which allows light to be emitted from the phosphors by selfluminescence. When the image display device according to the present invention is PDP, the above optical laminate may be provided on the surface of the surface glass substrate or on its front plate (glass substrate or film substrate).

Other spontaneous luminescent image display devices include image display devices such as ELD devices and CRTs. In the ELD device comprises a luminophor (zinc sulfide or a diamine compound which emits light upon the application of voltage) vapor deposited on a glass substrate, and display is carried out while regulating the voltage applied to the substrate. In the CRT, electric signals are converted to light which produces an image perceived by the human's eye. In this case, the above optical laminate may be provided on the uppermost surface of the display device or the surface of the front plate of the display device. All the above image display devices according to the present invention may be used for displays, for example, in televisions, computers, and word processors. Among others, the image display devices are preferably used on the surface of displays for high-definition images such as CRTs, liquid crystal panels, PDPs, ELDs, and FEDs.

### Second Aspect of Present Invention

### I. Member

The member according to the second aspect of the present invention can simultaneously realize antistatic properties and hard coat properties on the surface of the base material. This is derived from a unique structure of the member such that the electrolyte is homogeneously dispersed within the monomer, oligomer, or prepolymer and the monomer, oligomer, or prepolymer is exposed to heat and/or an ionizing radiation to cure the material and thus to form a three-dimensional network structure in which the electrolyte has been tightly bound.

Three-Dimensional Network Structure

In the present invention, the curing of the monomer forms a three-dimensional network structure (microorder to nanoorder) in which the electrolyte is homogeneously dispersed in and tightly bound within the structure. The reason why this phenomenon takes place has not been elucidated yet. The optical observation of the cross section of the member formed using the electrolyte has revealed that the electrolyte (liquid) is homogeneously dispersed in the above state within the three-dimensional network structure, more specifically that a very small amount of an electrolyte (a liquid) is stored in each compartment and homogeneously dispersed within the three-dimensional network structure.

Constituents

The reason why the member according to the present invention has the above-described unique structure is that the member according to the present invention comprises an electrolyte and a monomer, an oligomer or a prepolymer containing a plurality of functional groups curable upon exposure to heat and/or an ionizing radiation. The constituents may be the same as those described in the column of I. Composition in the first aspect of the present invention.

The amount of the electrolyte added is not less than 1% by weight and not more than 50% by weight based on the total amount of the components constituting the member. Preferably, the lower limit of the amount of the electrolyte added is 5% by weight, and the upper limit of the amount of the electrolyte added is 30% by weight. The amount of the monomer, oligomer, or prepolymer added is not less than 50% by weight and not more than 99% by weight based on the total amount of the components constituting the member. Preferably, the lower limit of the addition amount is 70% by weight, and the upper limit of the addition amount is 95% by weight. The amount of the anti-dazzling agent added is not less than 2% by weight and not more than 40% by weight based on the total amount of the components constituting the member. Preferably, the lower limit of the amount of the anti-dazzling agent added is 4% by weight, and the upper limit of the amount of the anti-dazzling agent added is 30% by weight. More preferably, the lower limit of the amount of the anti-dazzling agent added is 6% by weight, and the upper limit of the amount of the anti-dazzling agent added is 20% by weight. The amount of the refractive index regulating agent added is not less than 5% by weight and not more than 50% by weight based on the total amount of the components constituting the member. Preferably, the lower limit of the amount of the refractive index regulating agent added is 10% by weight, and the upper limit of the amount of the refractive index regulating agent added is 30% by weight. The amount of the antifouling agent added is not less than 1% by weight and not more than 35% by weight based on the total amount of the components constituting the member. Preferably, the lower limit of the amount of the antifouling agent added is 5% by weight, and the upper limit of the amount of the antifouling agent added is 20% by weight. The amount of the fluidity (hardness) regulating agent added is not less than 5% by weight and not more than 50% by weight based on the total amount of the components constituting the member. Preferably, the lower limit of the amount of the fluidity regulating agent added is 10% by weight, and the upper limit of the amount of the fluidity regulating agent added is 30% by weight.

### II. Ink Composition/(Optical) Single Layer Material

According to another aspect of the present invention, there is provided an ink composition which can realize the member according to the present invention. The ink composition for a member according to the present invention comprises an electrolyte and a monomer containing a plurality of functional groups curable upon exposure to heat and/or an ionizing radiation. The constituents of the ink composition according to the present invention may be the same as those described in the column of I. Composition in the first aspect of the present invention. According to a further aspect of the present invention, there is provided use of the member according to the present invention as a single layer material which can simultaneously realize antistatic properties and hard coat properties.

### III. (Optical) Laminate

In the preferred another aspect of the present invention, there is provided a laminate comprising a base material and an optical function layer provided on the base material, the optical function layer being the member according to the second aspect of the present invention. Accordingly, the member for constituting the (optical) laminate may be the same as that described above in the column of I. Member.

Optional Layers

In the present invention, one or at least two layers selected from the group consisting of an anti-dazzling layer, a refractive index regulating layer, and an antifouling layer may be further provided on the surface of the optical function layer or between the base material and the optical function layer and/or on the optical function layer. These layers may be formed using a composition produced by adding and dispersing an anti-dazzling agent, a refractive index regulating agent, or an antifouling agent, for example, into a resin. Accordingly, the anti-dazzling agent, the refractive index regulating agent, the antifouling agent, the resin and the like may be those described above in the column of I. Member.

Base Material

The (light transparent) base material may be the same as that described above in connection with First aspect of present invention.

Production Process

The member (single layer material) and (optical) laminate according to the present invention may be produced by mixing constituents for forming the member, the optical function layer, or optional layers together, optionally filtering the mixture, and drying and curing the components. Further, in the present invention, the member may be formed by coating components for constituting the member according to the present invention onto a product or a member. In the production process, the curing method, coating method and the like may be the same as described above in connection with First aspect of present invention.

### IV. Properties and Use of Member

Properties

The member according to the present invention, when formed, for example, as a film, a thin film, or a thin layer, the thickness is not less than 0.1 μm and not more than 10 μm, preferably not less than 1 μm and not more than 5 μm. This member has a high level of electrical conductivity on the order of less than 10¹⁰ Ω/cm², preferably on the order of 10⁸ Ω/cm² to 10⁹ Ω/cm². In particular, the electrical conductivity can easily be realized in the above layer thickness range. The hard coat properties of the cured antistatic member are such that the hardness is “H” or higher, preferably “2H” or higher, as measured in a pencil hardness test specified in JIS 5600-5-4 (1999). The properties other than the above properties may be the same as those described above in the column of II. Properties and use of composition in the first aspect of the present invention.

Use

The member according to the present invention may be used in products where antistatic properties (electrical conductivity) and hard coat properties are required. The member may be utilized, for example, in dust deposition preventive building materials (for example, decorative sheets) and overcoats provided on the surface of optical disks. The member according to the present invention can be utilized, for example, in the form of dried coated films, heat/light cured products, films, and molded products. Further, in the present invention, preferably, the member is used as an optically functional member. Accordingly, in another aspect of the present invention, there is provided an optical laminate (an antireflective member or a polarizing plate). The use other than mentioned above may be the same as described above in the column of II. Properties and use of composition in the first aspect of the present invention.

### Third Aspect of Present Invention

### I. Single Layer Material

The single layer material according to the third aspect of the present invention can simultaneously realize antistatic properties and hard coat properties. In the present invention, both the above properties can be realized by adopting both an electrolyte having antistatic properties and a monomer, an oligomer, or a prepolymer having hard coat properties in the single layer material.

Constituents

The constituents of a single layer material other than described below may be the same as those described in the column of I. Composition in the first aspect of the present invention.

The amount of the electrolyte added is not less than 1% by weight and not more than 50% by weight based on the total amount of the components for constituting the singe layer material. Preferably, the lower limit of the amount of the electrolyte added is 5% by weight, and the upper limit of the amount of the electrolyte added is 30% by weight. The amount of the monomer, oligomer, or prepolymer added is not less than 50% by weight and not more than 99% by weight based on the total amount of the components for constituting the singe layer material. Preferably, the lower limit of the addition amount is 70% by weight, and the upper limit of the addition amount is 95% by weight. The amount of the anti-dazzling agent added is not less than 2% by weight and not more than 40% by weight based on the total amount of the components for constituting the singe layer material. Preferably, the lower limit of the amount of the anti-dazzling agent added is 4% by weight, and the upper limit of the amount of the anti-dazzling agent added is 30% by weight. More preferably, the lower limit of the amount of the anti-dazzling agent added is 6% by weight, and the upper limit of the amount of the anti-dazzling agent added is 20% by weight. The amount of the refractive index regulating agent added is not less than 5% by weight and not more than 50% by weight based on the total amount of the components for constituting the singe layer material. Preferably, the lower limit of the amount of the refractive index regulating agent added is 10% by weight, and the upper limit of the amount of the refractive index regulating agent added is 30% by weight. The amount of the antifouling agent added is not less than 1% by weight and not more than 35% by weight based on the total amount of the components for constituting the singe layer material. Preferably, the lower limit of the amount of the antifouling agent added is 5% by weight, and the upper limit of the amount of the antifouling agent added is 20% by weight. The amount of the fluidity (hardness) regulating agent added is not less than 5% by weight and not more than 50% by weight based on the total amount of the components for constituting the singe layer material. Preferably, the lower limit of the amount of the fluidity regulating agent added is 10% by weight, and the upper limit of the amount of the fluidity regulating agent added is 30% by weight.

Production Process

The single layer material according to the present invention may be produced by mixing the constituents for forming the single layer material, together, optionally filtering the mixture, and drying and ultraviolet-curing the components. Further, in the present invention, the single layer material may be formed by coating components for constituting the single layer material according to the present invention onto a product or a member. In the production process, the curing method, coating method and the like may be the same as described above in connection with First aspect of present invention.

### II. Properties and Use of Single Layer Material

Properties

The single layer material according to the present invention, when formed, for example, as a film, a thin film, or a thin layer, the thickness is not less than 0.1 μm and not more than 10 μm, preferably not less than 1 μm and not more than 5 μm. This single layer material has a high level of electrical conductivity on the order of less than 10¹⁰ Ω/cm², preferably on the order of 10⁸ Ω/cm² to 10⁹ Ω/cm². In particular, the electrical conductivity can easily be realized in the above layer thickness range. The hard coat properties of the cured antistatic member are such that the hardness is “H” or higher, preferably “2H” or higher, as measured in a pencil hardness test specified in JIS 5600-5-4 (1999). The properties other than the above properties may be the same as those described above in the column of II. Properties and use of composition in the first aspect of the present invention.

Use

The single layer material according to the present invention as such may be used in products where antistatic properties (electrical conductivity) and hard coat properties are required. The single layer material may be utilized, for example, in dust deposition preventive building materials (for example, decorative sheets) and overcoats provided on the surface of optical disks. The single layer material according to the present invention can be utilized, for example, in the form of dried coated films, heat/light cured products, films, and molded products. Further, in the present invention, preferably, the single layer material is used as an optically functional member. Accordingly, in another aspect of the present invention, there is provided an optical laminate. The use other than mentioned above may be the same as described above in the column of II. Properties and use of composition in the first aspect of the present invention.

### Fourth Aspect of Present Invention

### I. Laminate

The laminate in the fourth aspect of the present invention comprises at least a base material and an optical function layer, which can simultaneously realize antistatic properties and hard coat properties, on a surface of the base material.

Optical Function Layer

The optical function layer according to the present invention can simultaneously realize both the above properties by adopting an electrolyte having antistatic properties and a monomer, an oligomer or a prepolymer having hard coat properties. The constituents of the optical function layer other than described below may be the same as those described in the column of I. Composition in the first aspect of the present invention. Further, optional layers, base material and the like may be the same as described above in the column of III. (Optical) Laminate in the second aspect of the present invention.

The amount of the electrolyte added is not less than 1% by weight and not more than 50% by weight based on the total amount of the components for constituting the optical function layer. Preferably, the lower limit of the amount of the electrolyte added is 5% by weight, and the upper limit of the amount of the electrolyte added is 30% by weight. The amount of the monomer, oligomer, or prepolymer added is not less than 50% by weight and not more than 99% by weight based on the total amount of the components for constituting the optical function layer. Preferably, the lower limit of the addition amount is 70% by weight, and the upper limit of the addition amount is 95% by weight. The amount of the anti-dazzling agent added is not less than 2% by weight and not more than 40% by weight based on the total amount of the components for constituting the optical function layer. Preferably, the lower limit of the amount of the anti-dazzling agent added is 4% by weight, and the upper limit of the amount of the anti-dazzling agent added is 30% by weight. More preferably, the lower limit of the amount of the anti-dazzling agent added is 6% by weight, and the upper limit of the amount of the anti-dazzling agent added is 20% by weight. The amount of the refractive index regulating agent added is not less than 5% by weight and not more than 50% by weight based on the total amount of the components for constituting the optical function layer. Preferably, the lower limit of the amount of the refractive index regulating agent added is 10% by weight, and the upper limit of the amount of the refractive index regulating agent added is 30% by weight. The amount of the antifouling agent added is not less than 1% by weight and not more than 35% by weight based on the total amount of the components for constituting the optical function layer. Preferably, the lower limit of the amount of the antifouling agent added is 5% by weight, and the upper limit of the amount of the antifouling agent added is 20% by weight. The amount of the fluidity (hardness) regulating agent added is not less than 5% by weight and not more than 50% by weight based on the total amount of the components for constituting the optical function layer. Preferably, the lower limit of the amount of the fluidity regulating agent added is 10% by weight, and the upper limit of the amount of the fluidity regulating agent added is 30% by weight.

Production Process

The laminate according to the present invention may be produced by mixing constituents for forming the optical function layer or optional layers together, optionally filtering the mixture, and drying and curing the components. Further, in the present invention, the laminate may be formed by coating components for constituting the laminate according to the present invention onto a product or a member. In the production process, the curing method, coating method and the like may be the same as described above in connection with First aspect of present invention.

### II. Properties and Use of Laminate

Properties

The laminate according to the present invention, when formed, for example, as a film, a thin film, or a thin layer, the thickness is not less than 0.1 μm and not more than 10 μm, preferably not less than 11 μm and not more than 5 μm. This laminate has a high level of electrical conductivity on the order of less than 10¹⁰ Ω/cm², preferably on the order of 10⁸ Ω/cm² to 10⁹ Ω/cm². In particular, the electrical conductivity can easily be realized in the above layer thickness range. The hard coat properties of the cured antistatic member are such that the hardness is “H” or higher, preferably “2H” or higher, as measured in a pencil hardness test specified in JIS 5600-5-4 (1999). The properties other than the above properties may be the same as those described above in the column of II. Properties and use of composition in the first aspect of the present invention.

Use

The laminate according to the present invention may be used in products where antistatic properties (electrical conductivity) and hard coat properties are required. The laminate may be utilized, for example, in dust deposition preventive building materials (for example, decorative sheets) and overcoats provided on the surface of optical disks. The laminate according to the present invention can be utilized, for example, in the form of dried coated films, heat/light cured products, films, and molded products. Further, in the present invention, preferably, the laminate is used as an optical function layer. Accordingly, in another aspect of the present invention, there is provided an optical laminate (an antireflective member or a polarizing plate). The use other than mentioned above may be the same as described above in the column of II. Properties and use of composition in the first aspect of the present invention.

### Fifth Aspect of Present Invention

### I. Composition

Constituents

The antistatic composition in the fifth aspect of the present invention comprises an electrolyte (preferably an ionic liquid) having antistatic properties and a resin. Further, in the present invention, hard coat properties may be imparted. The constituents of the antistatic composition other than described below may be the same as those described above in connection with the column of I. Composition in the first aspect of the present invention.

Ionic Liquid

In the fifth aspect of the present invention, an “ionic liquid” as an electroconductive material, which is liquid at room temperature, is used as the electrolyte. The “ionic liquid” is in a liquid state at room temperature and in a relatively low temperature range. Further, the “ionic liquid” shows, for example, high ion conductivity, high thermal stability, and relatively low viscosity and is characterized by having substantially no vapor pressure, having neither flammability nor combustibility, and having a broad liquid temperature range. The addition amount of the ionic liquid is not less than 1% by weight and not more than 50% by weight based on the total amount of the composition. Preferably, the lower limit of the amount of the ionic liquid added is 5% by weight, and the upper limit of the amount of the ionic liquid added is 30% by weight.

Resin

In the present invention, a resin is used. In the fifth to seventh aspects of the present invention, in some cases, a curable resin precursor such as a monomer, an oligomer, or a prepolymer is sometimes referred to as “resin,” unless otherwise specified. The details of the resin used in the present invention may be the same as those described above in the column of I. Composition in the first aspect of the present invention.

Monomer, Oligomer or Prepolymer (Hard Coat Properties)

In the present invention, monomers, oligomers or prepolymers, preferably those containing a plurality of functional groups curable upon exposure to heat and/or an ionizing radiation may be used as the resin. The resin is preferred particularly when hard coat properties are imparted to the antistatic layer. In particular, in the present invention, a composition for imparting a high level of antistatic properties and hard coat properties can be produced by mixing an ionic liquid with the above monomer or oligomer. The monomers, oligomers or prepolymers may be the same as described above in connection with the column of I. Composition in the first aspect of the present invention.

The amount of the resin added is not less than 50% by weight and not more than 99% by weight based on the total amount of the composition. Preferably, the lower limit of the amount of the resin added is 70% by weight, and the upper limit of the amount of the resin added is 95% by weight. The amount of the anti-dazzling agent added is not less than 5% by weight and not more than 40% by weight based on the total amount of the composition. Preferably, the lower limit of the amount of the anti-dazzling agent added is 10% by weight, and the upper limit of the amount of the anti-dazzling agent added is 30% by weight. The amount of the refractive index regulating agent added is not less than 5% by weight and not more than 40% by weight based on the total amount of the composition. Preferably, the lower limit of the amount of the refractive index regulating agent added is 10% by weight, and the upper limit of the amount of the refractive index regulating agent added is 30% by weight. The amount of the antifouling agent added is not less than 0.01% by weight and not more than 10% by weight based on the total amount of the composition. Preferably, the lower limit of the amount of the antifouling agent added is 0.1% by weight, and the upper limit of the amount of the antifouling agent added is 1% by weight. The amount of the fluidity regulating agent added is not less than 0.01% by weight and not more than 10% by weight based on the total amount of the composition. Preferably, the lower limit of the amount of the fluidity regulating agent added is 0.1% by weight, and the upper limit of the amount of the fluidity regulating agent added is 1% by weight. The amount of the monomer, oligomer, or prepolymer added is not less than 50% by weight and not more than 99% by weight based on the total amount of the composition. Preferably, the lower limit of the addition amount is 70% by weight, and the upper limit of the addition amount is 95% by weight.

### II. Properties and Use of Composition

Properties

The member produced by curing the composition according to the present invention, when formed, for example, as a film, a thin film, or a thin layer, the thickness is not less than 0.1 μm and not more than 10 μm, preferably not less than 1 μm and not more than 5 μm. This member has a high level of electrical conductivity on the order of less than 10¹⁰ Ω/cm², preferably on the order of 10⁸ Ω/cm² to 10⁹ Ω/cm². In particular, the electrical conductivity can easily be realized in the above layer thickness range. The properties other than the above properties may be the same as those described above in the column of II. Properties and use of composition in the first aspect of the present invention.

Use

The composition according to the present invention as such may be used in products where antistatic properties (electrical oconductivity) are required. In a preferred aspect of the present invention, a member, which can simultaneously realize antistatic properties and hard coat properties, can be provided. More preferably, a member produced by curing the composition according to the present invention can be provided. Accordingly, the member can be produced by coating the composition according to the present invention as such and curing the coating. The member may be utilized, for example, in dust deposition preventive building materials (for example, decorative sheets) and overcoats provided on the surface of optical disks. The antistatic composition can be utilized, for example, in the form of ink compositions, dried coated films, heat/light cured products, films, and molded products. The use other than mentioned above may be the same as described above in the column of II. Properties and use of composition in the first aspect of the present invention.

Specifically, a member having antistatic properties (electrical conductivity) can be produced by drying and curing the composition according to the present invention. The composition according to the present invention may be coated on to products or members. Regarding the production process, for example, the curing method and coating method may be the same as those described above in connection with First aspect of present invention.

### Sixth Aspect of Present Invention

### I. Single Layer Material

The single layer material according to the sixth aspect of the present invention comprises an electrolyte (preferably an ionic liquid) having antistatic properties and a resin.

Constituents

The constituents of a single layer material other than described below may be the same as those described in the column of I. Composition in the first aspect of the present invention and in the column of II. Composition in the fifth aspect of the present invention.

The amount of the ionic liquid added is not less than 1% by weight and not more than 50% by weight based on the total amount of the components for constituting the single layer material. Preferably, the lower limit of the amount of the ionic liquid added is 5% by weight, and the upper limit of the amount of the ionic liquid added is 30% by weight. The amount of the resin added is not less than 50% by weight and not more than 99% by weight based on the total amount of the components for constituting the single layer material. Preferably, the lower limit of the amount of the resin added is 70% by weight, and the upper limit of the amount of the resin added is 95% by weight. The amount of the anti-dazzling agent added is not less than 2% by weight and not more than 40% by weight based on the total amount of the components for constituting the single layer material. Preferably, the lower limit of the amount of the anti-dazzling agent added is 4% by weight, and the upper limit of the amount of the anti-dazzling agent added is 30% by weight. More preferably, the lower limit of the amount of the anti-dazzling agent added is 6% by weight, and the upper limit of the amount of the anti-dazzling agent added is 20% by weight. The amount of the refractive index regulating agent added is not less than 5% by weight and not more than 50% by weight based on the total amount of the components for constituting the single layer material. Preferably, the lower limit of the amount of the refractive index regulating agent added is 10% by weight, and the upper limit of the amount of the refractive index regulating agent added is 30% by weight. The amount of the antifouling agent added is not less than 1% by weight and not more than 35% by weight based on the total amount of the components for constituting the single layer material. Preferably, the lower limit of the amount of the antifouling agent added is 5% by weight, and the upper limit of the amount of the antifouling agent added is 20% by weight. The amount of the fluidity (hardness) regulating agent added is not less than 5% by weight and not more than 50% by weight based on the total amount of the components for constituting the single layer material. Preferably, the lower limit of the amount of the fluidity regulating agent added is 10% by weight, and the upper limit of the amount of the fluidity regulating agent added is 30% by weight. The amount of the monomer, oligomer, or prepolymer added is not less than 50% by weight and not more than 99% by weight based on the total amount of the components for constituting the single layer material. Preferably, the lower limit of the addition amount is 70% by weight, and the upper limit of the addition amount is 95% by weight.

Production Process

The single layer material according to the present invention may be produced by mixing the constituents for forming the single layer material, together, optionally filtering the mixture, and drying and ultraviolet-curing the components. Further, in the present invention, the single layer material may be formed by coating components for constituting the single layer material according to the present invention onto a product or a member. In the production process, the curing method, coating method and the like may be the same as described above in connection with First aspect of present invention.

### II. Properties and Use of Single Layer Material

Properties

The single layer material according to the present invention, when formed, for example, as a film, a thin film, or a thin layer, the thickness is not less than 0.1 μm and not more than 10 μm, preferably not less than 1 μm and not more than 5 μm. This single layer material has a high level of electrical conductivity on the order of less than 10¹⁰ Ω/cm², preferably on the order of 10⁸ Ω/cm² to 10⁹ Ω/cm². In particular, the electrical conductivity can easily be realized in the above layer thickness range. The properties other than the above properties may be the same as those described above in the column of II. Properties and use of composition in the first aspect of the present invention.

Use

The single layer material according to the present invention as such may be used in products where antistatic properties (electrical conductivity) are required. In a preferred aspect of the present invention, a single layer material, which can simultaneously realize antistatic properties and hard coat properties, can be provided. The single layer material may be utilized, for example, in dust deposition preventive building materials (for example, decorative sheets) and overcoats provided on the surface of optical disks. The single layer material according to the present invention can be utilized, for example, in the form of dried coated films, heat/light cured products, films, and molded products. Further, in the present invention, preferably, the single layer material is used as an optical function layer. Accordingly, in another aspect of the present invention, there is provided an optical laminate (an antireflection member and a polarizing plate). The use other than mentioned above may be the same as described above in the column of II. Properties and use of composition in the first aspect of the present invention.

### Seventh Aspect of Present Invention

### I. Laminate

The laminate in the seventh aspect of the present invention

comprises a base material and an optical function layer provided on the base material, wherein

the optical function layer is a single layer having antistatic properties and comprises an electrolyte (preferably an ionic liquid) having antistatic properties and a resin.

Optical Function Layer

The optical function layer according to the present invention is a single layer having antistatic properties, and antistatic properties can be realized by comprising an ionic liquid as an electrolyte, which is liquid at room temperature, and a resin.

Construction

The constituents of the laminate other than described below may be the same as those described in the column of I. Composition in the first aspect of the present invention and II. Composition in the fifth aspect of the present invention. Further, optional layers, base material and the like may be the same as described above in the column of III. (Optical) Laminate in the second aspect of the present invention.

The amount of the ionic liquid added is not less than 1% by weight and not more than 50% by weight based on the total amount of the components for constituting the optical function layer. Preferably, the lower limit of the amount of the ionic liquid added is 5% by weight, and the upper limit of the amount of the ionic liquid added is 30% by weight. The amount of the resin added is not less than 50% by weight and not more than 99% by weight based on the total amount of the components for constituting the optical function layer. Preferably, the lower limit of the amount of the resin added is 70% by weight, and the upper limit of the amount of the resin added is 95% by weight. The amount of the anti-dazzling agent added is not less than 2% by weight and not more than 40% by weight based on the total amount of the components for constituting the optical function layer. Preferably, the lower limit of the amount of the anti-dazzling agent added is 4% by weight, and the upper limit of the amount of the anti-dazzling agent added is 30% by weight. More preferably, the lower limit of the amount of the anti-dazzling agent added is 6% by weight, and the upper limit of the amount of the anti-dazzling agent added is 20% by weight. The amount of the refractive index regulating agent added is not less than 5% by weight and not more than 50% by weight based on the total amount of the components for constituting the optical function layer. Preferably, the lower limit of the amount of the refractive index regulating agent added is 10% by weight, and the upper limit of the amount of the refractive index regulating agent added is 30% by weight. The amount of the antifouling agent added is not less than 1% by weight and not more than 35% by weight based on the total amount of the components for constituting the optical function layer. Preferably, the lower limit of the amount of the antifouling agent added is 5% by weight, and the upper limit of the amount of the antifouling agent added is 20% by weight. The amount of the fluidity (hardness) regulating agent added is not less than 5% by weight and not more than 50% by weight based on the total amount of the components for constituting the optical function layer. Preferably, the lower limit of the amount of the fluidity regulating agent added is 10% by weight, and the upper limit of the amount of the fluidity regulating agent added is 30% by weight. The amount of the monomer, oligomer, or prepolymer added is not less than 50% by weight and not more than 99% by weight based on the total amount of the components for constituting the optical function layer. Preferably, the lower limit of the addition amount is 70% by weight, and the upper limit of the addition amount is 95% by weight.

Production Process

The laminate according to the present invention may be produced by mixing constituents for forming the optical function layer or optional layers together, optionally filtering the mixture, and drying and curing the components. Further, in the present invention, the laminate may be formed by coating components for constituting the single layer material according to the present invention onto a product or a member. In the production process, the curing method, coating method and the like may be the same as described above in connection with First aspect of present invention.

### II. Properties and Use of Laminate

Properties

The laminate according to the present invention, when formed, for example, as a film, a thin film, or a thin layer, the thickness is not less than 0.1 μm and not more than 10 μm, preferably not less than 1 μm and not more than 5 μm. This laminate has a high level of electrical conductivity on the order of less than 10¹⁰ Ω/cm², preferably on the order of 10⁸ Ω/cm² to 10⁹ Ω/cm². In particular, the electrical conductivity can easily be realized in the above layer thickness range. The properties other than the above properties may be the same as those described above in the column of II. Properties and use of composition in the fifth aspect of the present invention.

Use

The laminate according to the present invention as such may be used in products where antistatic properties (electrical conductivity) are required. The laminate may be utilized, for example, in dust deposition preventive building materials (for example, decorative sheets) and overcoats provided on the surface of optical disks. The laminate according to the present invention can be utilized, for example, in the form of dried coated films, heat/light cured products, films, and molded products. Further, in the present invention, preferably, the laminate is used as an optical function layer. Accordingly, in another aspect of the present invention, there is provided an optical laminate (an antireflective member or a polarizing plate). The use other than mentioned above may be the same as described above in the column of II. Properties and use of composition in the fifth aspect of the present invention.

### EXAMPLES

The following embodiments further illustrate the present invention. However, it should be noted that the contents of the present invention are not limited by these embodiments. The “parts” and “0%” are by mass unless otherwise specified.

First to Fourth Aspects of Present Invention
Abbreviations in Example A have the following respective meanings.
“TAC”: triacetylcellulose
“PET”: polyethylene terephthalate
“HC”: hard coat property or hard coat layer
“AS”: antistatic property or antistatic layer
“AG”: anti-dazzling property or anti-dazzling layer
“AR”: low-refractive index property or low-refractive index layer
“+”: means that a plurality of optical properties or optical function layers are provided.

Preparation of Composition

Composition for AS+HC Single Layer

The following components were homogeneously mixed together to prepare a composition which was then filtered through a polypropylene filter with a pore diameter of 30 μm to prepare a composition for an AS+HC single layer.

| | | |
|---|---|---|
| Ionic additive (ionic liquid): | 78 | pts. mass |
| 1-ethyl,3-methylimidazolium | | |
| “trifluoromethanesulfonate” | | |
| (manufactured by Stella Chemifa Corporation) | | |
| Pentaerythritol triacrylate | 100 | pts. mass |
| (manufactured by Nippon Kayaku | | |
| Co., Ltd., tradename “PET30”) | | |
| Methyl ethyl ketone | 43 | pts. mass |
| Leveling agent | 2 | pts. mass |
| (manufactured by Dainippon Ink and | | |
| Chemicals, Inc, tradename “MCF-350-5”) | | |
| Polymerization initiator | 4 | pts. mass |
| (manufactured by Ciba Specialty | | |
| Chemicals, K.K., tradename “Irgacure 184”) | | |

Composition for HC Single Layer

A composition for an HC single layer was produced in the same manner as in the composition for an AS+HC single layer, except that any ionic additive was not added.

Composition 1 for AS Single Layer

The following components were homogeneously mixed together to prepare a composition which was then filtered through a polypropylene filter with a pore diameter of 30 μm to prepare a composition 1 for an AS single layer.

| | | |
|---|---|---|
| ATO dispersion liquid | 25 | pts. mass |
| (manufactured by NIPPON PELNOX CORP., | | |
| tradename “PELTRON C-4456S-7”) | | |
| Binder | 5.5 | pts. mass |
| (manufactured by Sartomar Company, | | |
| tradename “SR-238F”) | | |
| Polymerization initiator (“Irgacure 184”) | 0.58 | pt. mass |
| (manufactured by Ciba Specialty | | |
| Chemicals, K.K., tradename) | | |
| Methyl isobutyl ketone | 59 | pts. mass |
| Cyclohexanone | 26 | pts. mass |

Composition 2 for AS Single Layer

A lithiophene-containing heat drying-type resin composition (manufactured by Idemitsu Technofine Co., Ltd., tradename “EL Coat TALP2010”) was used as a composition 2 for an AS single layer. The composition 2 for an AS single layer comprised poly(3,4-ethylenedioxythiophene) as an antistatic agent and an MMA(methyl methacrylate)-BA(butyl acrylate)-2-HEMA(2-hydroxyethyl methacrylate) copolymer as a thermoplastic resin binder.

Composition for AS+HC+AG Single Layer

The following components were homogeneously mixed together to prepare a composition which was then filtered through a polypropylene filter with a pore diameter of 30 μm to prepare a composition for an AS+HC+AG single layer.

| | | |
|---|---|---|
| Ionic additive (ionic liquid): | 15.000 | pts. mass |
| 1-ethyl,3-methylimidazolium | | |
| “trifluoromethanesulfonate” | | |
| (manufactured by Stella Chemifa Corporation) | | |
| Pentaerythritol triacrylate (PETA) | 18.22 | pts. mass |
| (manufactured by Nippon Kayaku | | |
| Co., Ltd., refractive index 1.51) | | |
| Dipentaerythritol hexaacrylate (DPHA) | 7.00 | pts. mass |
| (manufactured by Nippon Kayaku | | |
| Co., Ltd.,, refractive index 1.51) | | |
| Acrylic polymer | 2.69 | pts. mass |
| (manufactured by Mitsubishi Rayon | | |
| Co., Ltd., molecular weight 75,000) | | |
| Photocuring initiator (Irgacure 184) | 1.64 | pts. mass |
| (manufactured by Chiba Specialty | | |
| Chemicals K.K.) | | |
| Photocuring initiator (Irgacure 907) | 0.28 | pt. mass |
| (manufactured by Chiba Specialty | | |
| Chemicals K.K.) | | |
| Styrene beads | 4.18 | pts. mass |
| (first light transparent fine particles) | | |
| (manufactured by Soken Chemical | | |
| Engineering Co., Ltd., | | |
| particle diameter 5.0 μm, refractive index 1.60) | | |
| Melamine beads | 2.51 | pts. mass |
| (second light transparent fine particles) | | |
| (manufactured by Nippon Shokubai | | |
| Kagaku Kogyo Co., Ltd., | | |
| particle diameter 1.8 μm, refractive index 1.68) | | |
| Silicone leveling agent (10-28: | 0.010 | pt. mass |
| manufactured by Dainichiseika Color & | | |
| Chemicals Manufacturing Co., Ltd.) | | |
| Toluene | 40.30 | pts. mass |
| Cyclohexanone | 10.08 | pts. mass |

Composition for AG Single Layer

A composition for an AG single layer was produced in the same manner as in the composition for an AS+HC+AG single layer, except that any ionic additive was not added.

Composition for AS+HC+AR Single Layer

The following components were homogeneously mixed together to prepare a composition which was then filtered through a polypropylene filter with a pore diameter of 30 μm to prepare a composition 1 for an antistatic property imparting low-refractive index layer.

| | | |
|---|---|---|
| Treated silica sol-containing solution | 15.2 | pts. mass |
| (in which the surface of empty fine particles | | |
| having a silica sol solid content of 20% | | |
| by mass has been treated with a silane | | |
| coupling agent for holding dispersion stability) | | |
| Ionic additive (ionic liquid) | 1.23 | pts. mass |
| 1-ethyl,3-methylimidazolium | | |
| “trifluoromethanesulfonate” | | |
| (manufactured by Stella Chemifa Corporation) | | |
| Pentaerythritol triacrylate (PETA) | 1.58 | pts. mass |
| Polymerization initiator (Irgacure 127) | 0.10 | pt. mass |
| (manufactured by Ciba Specialty Chemicals, K.K.) | | |
| Modified silicone oil (X22164E; manufactured | 0.15 | pt. mass |
| by The Shin-Etsu Chemical Co., Ltd.) | | |
| Methyl isobutyl ketone | 80.0 | pts. mass |

Composition for AR Single Layer

A composition for an AR single layer was produced in the same manner as in the composition for an AS+HC+AR single layer, except that any ionic additive was not added.

Preparation of Member (Laminate)

### Example A1

### TAC/AS+HC

A TAC transparent base material (thickness 80 μm: manufactured by Fuji Photo Film Co., Ltd., tradename “TF80UL”) was provided. The composition for an AS+HC single layer was bar coated onto one side of the base material, and the assembly was held in a hot oven of 70° C. for 30 sec to evaporate the solvent contained in the coating film. Thereafter, the coating film was cured by ultraviolet irradiation at an integrated light quantity of 50 mJ/cm². Thus, a member having an AS+HC single layer construction with a thickness of 5 μm (on a dry basis) was provided.

### Example A2

### PET/AS+HC/AR

A PET transparent base material (thickness 80 μm: manufactured by Toyobo Co., Ltd., tradename “A-4100”) was provided. The composition for an AS+HC single layer was bar coated onto an easy-adhesion face of the base material. The assembly was held in a hot oven of 70° C. for 30 sec to evaporate the solvent contained in the coating film. The coating film was then cured by ultraviolet irradiation with an ultraviolet irradiation system (Fusion UV system Japan KK) at an integrated light quantity of 50 mJ/cm². Thus, an AS+HC single layer with a thickness of 7 μm (on a dry basis) was formed. Further, the composition for an AR single layer was bar coated onto the surface of the single layer to a thickness of about 100 nm (on a dry basis), and the coating was dried at 50° C. to evaporate the solvent. The coating film was then cured by ultraviolet irradiation with an ultraviolet irradiation system (Fusion UV system Japan KK) at an integrated light quantity of 200 mJ/cm². Thus, a member having an AS+HC/AR layer construction with a thickness of 7 μm (on a dry basis) was provided.

### Example A3

### TAC/AS+HC+AG

A TAC transparent base material (thickness 80 μm: manufactured by Fuji Photo Film Co., Ltd., tradename “TF80UL”) was provided. The composition for an AS+HC+AG single layer was bar coated onto the surface of the base material, and the assembly was heat dried in a hot oven of 70° C. for 1 min to evaporate the solvent. Thereafter, the coating film was cured by ultraviolet irradiation at a dose of 100 mJ/cm². Thus, a member having an AS+HC+AG single layer construction with a thickness of 5 μm (on a dry basis) was provided.

### Example A4

### TAC/AG/AS+HC+AR

A transparent base material (thickness 80 μm, a triacetylcellulose resin film (manufactured by Fuji Photo Film Co., Ltd., tradename “TF80UL”) was provided. The composition for an AG single layer was bar coated onto one side of the base material, and the assembly was held in a hot oven of 50° C. for 30 sec to evaporate the solvent contained in the coating film and to cure the coating film. Thus, an AG layer was formed. Thereafter, the composition for an AS+HC+AR single layer was coated onto the AG layer, and the assembly was held in a hot oven of 70° C. for 30 sec to evaporate the solvent contained in the coating film. The coating film was then cured by ultraviolet irradiation at an integrated light quantity of 50 mJ/cm² to provide a member having an AG/AS+HC+AR layer construction with a thickness of 10 μm (on a dry basis).

### Comparative Example A1

### TAC

A transparent base material (thickness 80 μm, a triacetylcellulose resin film (manufactured by Fuji Photo Film Co., Ltd., tradename “TF80UL”) was used.

### Comparative Example A2

### TAC/HC

A member was produced in quite the same manner as in Example A1, except that the composition for an AS+HC single layer was changed to the composition for an HC single layer.

### Comparative Example A3

### PET/HC/AR

A member was produced in quite the same manner as in Example A2, except that the composition for an AS+HC single layer was changed to the composition for an HC single layer.

### Comparative Example A4

### TAC/AS/HC

A transparent base material (thickness 80 μm, a triacetylcellulose resin film (manufactured by Fuji Photo Film Co., Ltd., tradename “TF80UL”) was provided. The composition 1 for an AS single layer was bar coated onto one side of the base material, and the assembly was held in a hot oven of 50° C. for 30 sec to evaporate the solvent contained in the coating film and to cure the coating film. Thus, a transparent AS layer having a thickness of about 100 nm (on a dry basis) was formed. Thereafter, the composition for an HC single layer was bar coated onto the AS layer, and the assembly was held in a hot oven of 70° C. for 30 sec to evaporate the solvent contained in the coating film. The coating film was then cured by ultraviolet irradiation at an integrated light quantity of 50 mJ/cm² to provide a member having an AS/HC layer construction with a thickness of 10 μm (on a dry basis).

### Comparative Example A5

### TAC/AS/HC

A member was produced in the same manner as in Comparative Example A4, except that the composition 1 for an AS single layer was changed to the composition 2 for an AS single layer.

### Comparative Example A6

### TAC/AS/HC/AR

The composition for an AR single layer was bar coated onto the surface of HC layer produced in Comparative Example A4, and the coating was dried at 50° C. to remove the solvent. Thereafter, the coating film was cured by ultraviolet irradiation with an ultraviolet irradiation system at an integrated light quantity of 200 mJ/cm² to provide a member having an AS/HC/AR layer construction with a thickness of about 10 μm (on a dry basis).

### Comparative Example A7

### TAC/AG

A member was produced in quite the same manner as in Example A3, except that the composition for an AS+HC+AG single layer was changed to the composition for an AG single layer.

### Comparative Example A8

### TAC/AG/AR

A member was produced in quite the same manner as in Example A4, except that the composition for an AS+HC+AR single layer was changed to the composition for an AR single layer.

### Comparative Example A9

### TAC/AS/AG/AR

A transparent base material (thickness 80 μm, a triacetylcellulose resin film (manufactured by Fuji Photo Film Co., Ltd., tradename “TF80UL”) was provided. The composition 1 for an AS single layer was bar coated onto one side of the base material, and the assembly was held in a hot oven of 50° C. for 30 sec to evaporate the solvent contained in the coating film and to cure the coating film. Thus, a transparent AS layer having a thickness of about 100 nm (on a dry basis) was formed. Thereafter, the composition for an AG single layer was coated onto the AS layer, and the assembly was held in a hot oven of 70° C. for 30 sec to evaporate the solvent contained in the coating film. The coating film was then cured by ultraviolet irradiation at an integrated light quantity of 50 mJ/cm² to stack an AG layer. Further, the composition for an AR single layer was bar coated onto the surface of the AG layer, and the coating was dried at 50° C. to remove the solvent. Thereafter, the coating film was cured by ultraviolet irradiation with an ultraviolet irradiation system at an integrated light quantity of 200 mJ/cm² to provide a member.

Evaluation Tests

For the members of Examples and Comparative Examples, the surface resistance values (Ω/cm²) after the following tests were measured and were described in Table 1. The surface resistance values (Ω/cm²) were measured with a surface resistivity measuring apparatus (manufactured by Mitsubishi Chemical Corporation, product No.; Hiresta IP MCP-HT260). In the table, 10ⁿ means 1×10ⁿ Ω/cm².

Evaluation 1: Initial Surface Resistance Measuring Test

Before carrying out a heat resistance test, a lightfastness test, and a moist heat resistance test, the surface resistance values were measured with the above measuring apparatus. When the surface resistance value is less than the order of 10¹⁰ Ω/cm², the member was regarded as an acceptable member. On the other hand, when the surface resistance value does not satisfy the above surface resistance value requirement, the member was regarded as an unacceptable member. For the members of Comparative Examples wherein conventional antistatic materials were used, unlike the members of the present invention, none of the members were acceptable.

Evaluation 2: Surface Resistance Value Measurement After Heat Resistance Test

Each member was allowed to stand in an oven of 90° C. for 250 hr and was then subjected to surface resistance value measurement with the above measuring apparatus.

Evaluation 3: Surface Resistance Value Measurement After Lightfastness Test

Each member was exposed to carbon arc light for 100 hr with a lightfastness tester (manufactured by Suga Test Instruments Co., Ltd., tradename; Fade Meter) and was then subjected to surface resistance value R2 measurement with the above measuring apparatus to determine an R1 (measured value in evaluation 1)/R2 ratio.

Evaluation 4: Moist Heat Resistance Test

Each member was subjected to a 500-hr lightfastness test under high temperature and high humidity conditions of temperature 80° C. and humidity 90% and was then subjected to surface resistivity R2′ measurement with the measuring apparatus. The ratio of the surface resistivity R1′ before the lightfastness test (measured value in evaluation 1) to the surface resistivity R2′ after the lightfastness test was determined.

Evaluation 5: Level of Coloring of Member (Laminate)

For each member which could have successfully subjected to surface resistance value measurement in evaluation 1, the level of coloring depending upon the antistatic material was visually observed. A member cut into a square shape having a size of 10 cm×10 cm was applied at its four vertexes onto a standard copying paper (manufactured by FUJI XEROX OFFICE SUPPLY Co., Ltd., tradename Ncolor081, size A3 and the like) with a tape. The assembly was visually observed from about 30 cm above the assembly under a fluorescent lamp. A transparent base materials (TAC, PET) used in the production of the members was applied as a blank in the same manner as described above, and the observation results were compared. When the color was the same as that of the blank, the member was evaluated as an acceptable member. On the other hand, when the color was other than that in the acceptable member, the member was evaluated as an unacceptable member.

TABLE 1

| | evaluation | | | | |
|---|---|---|---|---|---|
| Example | Evaluation 1 | Evaluation 2 | Evaluation 3 | Evaluation 4 | Evaluation 5 |
| Ex. A1 | 10⁸ | 10⁸ | 1 | 1 | Acceptable |
| Ex. A2 | 10⁸ | 10⁸ | 1 | 1 | Acceptable |
| Ex. A3 | 10⁸ | 10⁸ | 1 | 1 | Acceptable |
| Ex. A4 | 10⁸ | 10⁸ | 1 | 1 | Acceptable |
| Ex. A5 | 10⁸ | 10⁹ | 10 | 1 | Acceptable |
| Ex. A6 | 10⁸ | 10⁹ | 10 | 1 | Acceptable |
| Comp. Ex. | — | — | — | — | — |
| A1 | | | | | |
| Comp. Ex. | — | — | — | — | — |
| A3 | | | | | |
| Comp. Ex. | — | — | — | — | — |
| A3 | | | | | |
| Comp. Ex. | 10¹⁰ | 10¹⁰ | 1 | 1 | Unacceptable |
| A4 | | | | | |
| Comp. Ex. | 10¹⁰ | 10¹⁰ | 100 | 10 | Unacceptable |
| A5 | | | | | |
| Comp. Ex. | 10¹² | 10¹² | 1 | 1 | Unacceptable |
| A6 | | | | | |
| Comp. Ex. | — | — | — | — | — |
| A7 | | | | | |
| Comp. Ex. | 10¹⁰ | 10¹⁰ | 1 | 1 | Unacceptable |
| A8 | | | | | |
| Comp. Ex. A9 | 10¹⁰ | 10¹⁰ | 1 | 1 | Unacceptable |

In Table 1, “—” means over range.

Fifth to Seventh Aspects of Present Invention

Abbreviations in Example B have the following respective meanings.
“TAC”: triacetylcellulose
“PET”: polyethylene terephthalate
“HC”: hard coat property or hard coat layer
“AS”: antistatic property or antistatic layer
“AG”: anti-dazzling property or anti-dazzling layer
“AR”: low-refractive index property or low-refractive index layer
“+”: means that a plurality of optical properties or optical function layers are provided.

Preparation of Composition

Composition 1 for AS Single Layer

The following components were homogeneously mixed together to prepare a composition which was then filtered through a polypropylene filter with a pore diameter of 30 μm to prepare a composition 1 for an AS single layer.

| | | |
|---|---|---|
| Ionic additive (ionic liquid): | 4.3 | pts. mass |
| 1-ethyl,3-methylimidazolium | | |
| “trifluoromethanesulfonate” | | |
| (manufactured by Stella Chemifa Corporation) | | |
| Binder (tradename “SR-238F”) | 5.5 | pts. mass |
| (manufactured by Sartomar Company) | | |
| Polymerization initiator (“Irgacure 184”) | 0.62 | pt. mass |
| (manufactured by Ciba Specialty | | |
| Chemicals, K.K.) | | |
| Methyl isobutyl ketone | 59 | pts. mass |
| Cyclohexanone | 26 | pts. mass |

Composition 2 for AS Single Layer

### Comparative Example B

The following components were homogeneously mixed together to prepare a composition which was then filtered through a polypropylene filter with a pore diameter of 30 μm to prepare a composition 2 for an AS single layer.

| | | |
|---|---|---|
| ATO dispersion liquid | 25 | pts. mass |
| (manufactured by NIPPON PELNOX CORP., | | |
| tradename “PELTRON C-4456S-7”) | | |
| Binder | 5.5 | pts. mass |
| (manufactured by Sartomar Company, | | |
| tradename “SR-238F”) | | |
| Polymerization initiator (“Irgacure 184”) | 0.58 | pt. mass |
| (manufactured by Ciba Specialty | | |
| Chemicals, K.K., tradename) | | |
| Methyl isobutyl ketone | 59 | pts. mass |
| Cyclohexanone | 26 | pts. mass |

Composition 3 for AS Single Layer

### Comparative Example B

A lithiophene-containing heat drying-type resin composition (manufactured by Idemitsu Technofine Co., Ltd., tradename “EL Coat TALP2010”) was used as a composition 3 for an AS single layer. The composition 3 for an AS single layer comprised poly(3,4-ethylenedioxythiophene) as an antistatic agent and an MMA(methyl methacrylate)-BA(butyl acrylate)-2-HEMA(2-hydroxyethyl methacrylate) copolymer as a thermoplastic resin binder.

Composition for AS+HC Single Layer

The following components were homogeneously mixed together to prepare a composition which was then filtered through a polypropylene filter with a pore diameter of 30 μm to prepare a composition for an AS+HC single layer.

| | | |
|---|---|---|
| Ionic additive (ionic liquid): | 78 | pts. mass |
| 1-ethyl,3-methylimidazolium | | |
| “trifluoromethanesulfonate” | | |
| (manufactured by Stella Chemifa Corporation) | | |
| Pentaerythritol triacrylate | 100 | pts. mass |
| (manufactured by Nippon Kayaku | | |
| Co., Ltd., tradename “PET30”) | | |
| Methyl ethyl ketone | 43 | pts. mass |
| Leveling agent | 2 | pts. mass |
| (manufactured by Dainippon Ink and | | |
| Chemicals, Inc, tradename “MCF-350-5”) | | |
| Polymerization initiator | 4 | pts. mass |
| (manufactured by Ciba Specialty | | |
| Chemicals, K.K., tradename “Irgacure 184”) | | |

Composition for HC Single Layer

A composition for an HC single layer was produced in the same manner as in the composition for an AS+HC single layer, except that any ionic additive was not added.

Composition for AS+HC+AG Single Layer

The following components were homogeneously mixed together to prepare a composition which was then filtered through a polypropylene filter with a pore diameter of 30 μm to prepare a composition for an AS+HC+AG single layer.

| | | |
|---|---|---|
| Pentaerythritol triacrylate (PETA) | 18.22 | pts. mass |
| (manufactured by Nippon Kayaku | | |
| Co., Ltd., refractive index 1.51) | | |
| Dipentaerythritol hexaacrylate (DPHA) | 7.00 | pts. mass |
| (manufactured by Nippon Kayaku | | |
| Co., Ltd.,, refractive index 1.51) | | |
| Acrylic polymer | 2.69 | pts. mass |
| (manufactured by Mitsubishi Rayon | | |
| Co., Ltd., molecular weight 75,000) | | |
| Photocuring initiator (Irgacure 184) | 1.64 | pts. mass |
| (manufactured by Chiba Specialty | | |
| Chemicals K.K.) | | |
| Photocuring initiator (Irgacure 907) | 0.28 | pt. mass |
| (manufactured by Chiba Specialty | | |
| Chemicals K.K.) | | |
| Styrene beads | 4.18 | pts. mass |
| (first light transparent fine particles) | | |
| (manufactured by Soken Chemical | | |
| Engineering Co., Ltd., | | |
| particle diameter 5.0 μm, refractive index 1.60) | | |
| Melamine beads | 2.51 | pts. mass |
| (second light transparent fine particles) | | |
| (manufactured by Nippon Shokubai | | |
| Kagaku Kogyo Co., Ltd., | | |
| particle diameter 1.8 μm, refractive index 1.68) | | |
| Silicone leveling agent (10-28: | 0.010 | pt. mass |
| manufactured by Dainichiseika Color & | | |
| Chemicals Manufacturing Co., Ltd.) | | |
| Ionic additive (ionic liquid): | 15.000 | pts. mass |
| 1-ethyl,3-methylimidazolium | | |
| “trifluoromethanesulfonate” | | |
| (manufactured by Stella Chemifa Corporation) | | |
| Toluene | 40.30 | pts. mass |
| Cyclohexanone | 10.08 | pts. mass |

Composition for AG Single Layer

A composition for an AG single layer was produced in the same manner as in the composition for an AS+HC+AG single layer, except that any ionic additive was not added.

Composition for AS+HC+AR Single Layer

The following components were homogeneously mixed together to prepare a composition which was then filtered through a polypropylene filter with a pore diameter of 30 μm to prepare a composition for an AS+HC+AG single layer.

| | | |
|---|---|---|
| Treated silica sol-containing solution | 15.2 | pts. mass |
| (in which the surface of empty fine particles | | |
| having a silica sol solid content of 20% | | |
| by mass has been treated with a silane | | |
| coupling agent for holding dispersion stability) | | |
| Pentaerythritol triacrylate (PETA) | 1.58 | pts. mass |
| Ionic additive (ionic liquid) | 1.23 | pts. mass |
| 1-ethyl,3-methylimidazolium | | |
| “trifluoromethanesulfonate” | | |
| (manufactured by Stella Chemifa Corporation) | | |
| Polymerization initiator (Irgacure 127) | 0.10 | pt. mass |
| (manufactured by Ciba Specialty Chemicals, K.K.) | | |
| Modified silicone oil (X22164E; manufactured | 0.15 | pt. mass |
| by The Shin-Etsu Chemical Co., Ltd.) | | |
| Methyl isobutyl ketone | 80.0 | pts. mass |

Composition for AR Single Layer

A composition for an AR single layer was produced in the same manner as in the composition for an AS+HC+AR single layer, except that any ionic additive was not added.

Preparation of Member (Optical Laminate)

### Example B1

### TAC/AS/HC

A TAC transparent base material (thickness 80 μm: manufactured by Fuji Photo Film Co., Ltd., tradename “TF80UL”) was provided. The composition 1 for an AS single layer was bar coated onto one side of the base material, and the assembly was held in a hot oven of 50° C. for 30 sec to evaporate the solvent contained in the coating film and to cure the coating film. Thus, a transparent AS layer having a thickness of about 100 nm (on a dry basis) was formed. Thereafter, the composition for an HC single layer was coated onto the AS layer, and the assembly was held in a hot oven of 70° C. for 30 sec to evaporate the solvent contained in the coating film. The coating film was then cured by ultraviolet irradiation at an integrated light quantity of 50 mJ/cm² to provide a member (optical laminate) having an HC layer construction with a thickness of 10 μm (on a dry basis).

### Example B2

### TAC/AS/HC/AR

The composition for an AR single layer was bar coated onto the surface of HC layer of an optical laminate produced in Example B1 (a thickness of about 100 nm (on a dry basis)), and the coating was dried at 50° C. to remove the solvent. Thereafter, the coating film was cured by ultraviolet irradiation with an ultraviolet irradiation system at an integrated light quantity of 200 mJ/cm² to provide a member (optical laminate).

### Example B3

### TAC/AS/AG/AR

A TAC transparent base material (thickness 80 μm: manufactured by Fuji Photo Film Co., Ltd., tradename “TF80UL”) was provided. The composition 1 for an AS single layer was bar coated onto one side of the base material, and the assembly was held in a hot oven of 50° C. for 30 sec to evaporate the solvent contained in the coating film and to cure the coating film. Thus, a transparent AS layer having a thickness of about 100 nm (on a dry basis) was formed. Thereafter, the composition for an AG single layer was coated onto the AS layer, and the assembly was held in a hot oven of 70° C. for 30 sec to evaporate the solvent contained in the coating film. The coating film was then cured by ultraviolet irradiation at an integrated light quantity of 50 mJ/cm² to stack an AG layer having a thickness of 3 μm (on a dry basis). Further, the composition for an AR single layer was bar coated onto the surface of the AG layer, and the coating was dried at 50° C. to remove the solvent. Thereafter, the coating film was cured by ultraviolet irradiation with an ultraviolet irradiation system at an integrated light quantity of 200 mJ/cm² to provide a member (optical laminate).

### Example B4

### TAC/AS+HC

A TAC transparent base material (thickness 80 μm: manufactured by Fuji Photo Film Co., Ltd., tradename “TF80UL”) was provided. The composition for an AS+HC single layer was bar coated onto one side of the base material, and the assembly was held in a hot oven of 70° C. for 30 sec to evaporate the solvent contained in the coating film. Thereafter, the coating film was cured by ultraviolet irradiation at an integrated light quantity of 50 mJ/cm². Thus, a member (optical laminate) having an AS+HC single layer construction with a thickness of 5 μm (on a dry basis) was provided.

### Example B5

### PET/AS+HC/AR

A PET transparent base material (thickness 80 μm: manufactured by Toyobo Co., Ltd., tradename “A-4100”) was provided. The composition for an AS+HC single layer was bar coated onto an easy-adhesion face of the base material. The assembly was held in a hot oven of 70° C. for 30 sec to evaporate the solvent contained in the coating film. The coating film was then cured by ultraviolet irradiation with an ultraviolet irradiation system (Fusion UV system Japan KK) at an integrated light quantity of 50 mJ/cm². Thus, an AS+HC single layer with a thickness of 7 μm (on a dry basis) was formed. Further, the composition for an AR single layer was bar coated onto the surface of the single layer to a thickness of about 100 nm (on a dry basis), and the coating was dried at 50° C. to remove the solvent. The coating film was then cured by ultraviolet irradiation with an ultraviolet irradiation system (Fusion UV system Japan KK) at an integrated light quantity of 200 mJ/cm². Thus, a member (optical laminate) was provided.

### Example B6

### PET/HC/AS+HC+AR

A transparent base material (thickness 80 μm, a polyethylene terephthalate resin film (manufactured by Toyobo Co., Ltd., tradename “A-4100”) was provided. The composition for an HC single layer was bar coated onto an easy-adhesion face of the base material. The assembly was held in a hot oven of 70° C. for 30 sec to evaporate the solvent contained in the coating film. The coating film was then cured by ultraviolet irradiation with an ultraviolet irradiation system (Fusion UV system Japan KK) at an integrated light quantity of 50 mJ/cm². Thus, an HC layer with a thickness of 7 μm (on a dry basis) was formed. Further, the composition for an AS+HC+AR single layer was bar coated onto the surface of the HC layer to a thickness of about 100 nm (on a dry basis), and the coating was dried at 50° C. to remove the solvent. The coating film was then cured by ultraviolet irradiation with an ultraviolet irradiation system (Fusion UV system Japan KK) at an integrated light quantity of 200 mJ/cm². Thus, a member (optical laminate) was provided.

### Example B7

### TAC/AS+HC+AG

A TAC transparent base material (thickness 80 μm: manufactured by Fuji Photo Film Co., Ltd., tradename “TF80UL”) was provided. The composition for an AS+HC+AG single layer having a thickness of 4 μm (on a dry basis) was bar coated onto the surface of the base material, and the assembly was heat dried in a hot oven of 70° C. for 1 min to evaporate the solvent. Thereafter, the coating film was cured by ultraviolet irradiation at a dose of 100 mJ/cm². Thus, a member (optical laminate) was provided.

### Example B8

### TAC/AS+HC+AG/AR

The composition for an AR single layer was bar coated onto the surface of AG layer of the member (optical laminate) produced in Example B7, and the coating was dried at 50° C. to remove the solvent. Thereafter, the coating film was cured by ultraviolet irradiation with an ultraviolet irradiation system at an integrated light quantity of 200 mJ/cm² to provide a member (optical laminate).

### Example B9

### TAC/AG/AS+HC+AR

A transparent base material (thickness 80 μm, a triacetylcellulose resin film (manufactured by Fuji Photo Film Co., Ltd., tradename “TF80UL”) was provided. The composition for an AG single layer was bar coated onto one side of the base material, and the assembly was held in a hot oven of 50° C. for 30 sec to evaporate the solvent contained in the coating film and to cure the coating film. Thus, a transparent AG layer having a thickness of 10 μm was formed. Thereafter, the composition for an AS+HC+AR single layer was coated onto the AG layer, and the assembly was held in a hot oven of 70° C. for 30 sec to evaporate the solvent contained in the coating film. The coating film was then cured by ultraviolet irradiation at an integrated light quantity of 50 mJ/cm² to provide a member (optical laminate) having a total coating film thickness of about 10 μm (on a dry basis).

### Example B10

### PET/AS+HC/AS+HC+AR

A transparent base material (thickness 80 μm, a polyethylene terephthalate resin film (manufactured by Toyobo Co., Ltd., tradename “A-4100”) was provided. The composition for an AS+HC single layer was bar coated onto an easy-adhesion face of the base material in the same manner as in Example B1. The assembly was held in a hot oven of 70° C. for 30 sec to evaporate the solvent contained in the coating film. The coating film was then cured by ultraviolet irradiation with an ultraviolet irradiation system (Fusion UV system Japan KK) at an integrated light quantity of 50 mJ/cm². Thus, an AS+HC layer with a thickness of 7 μm (on a dry basis) was formed. Further, the composition for an AS+HC+AR single layer was bar coated onto the surface of the AS+HC layer to a thickness of about 100 nm (on a dry basis), and the coating was dried at 50° C. to remove the solvent. The coating film was then cured by ultraviolet irradiation with an ultraviolet irradiation system (Fusion UV system Japan KK) at an integrated light quantity of 200 mJ/cm². Thus, a member (optical laminate) was provided.

### Comparative Example B1

### TAC/AS/HC

A transparent base material (thickness 80 μm, a triacetylcellulose resin film (manufactured by Fuji Photo Film Co., Ltd., tradename “TF80UL”) was provided. The composition 2 for an AS single layer was bar coated onto one side of the base material, and the assembly was held in a hot oven of 50° C. for 30 sec to evaporate the solvent contained in the coating film and to cure the coating film. Thus, a transparent AS layer having a thickness of about 100 nm (on a dry basis) was formed. Thereafter, the composition for an HC single layer was bar coated onto the AS layer, and the assembly was held in a hot oven of 70° C. for 30 sec to evaporate the solvent contained in the coating film. The coating film was then cured by ultraviolet irradiation at an integrated light quantity of 50 mJ/cm² to form a hard coat layer having a thickness of 10 μm (on a dry basis). Thus, a member (optical laminate) was provided.

### Comparative Example B2

### TAC/AS/HC

A member (optical laminate) was produced in the same manner as in Comparative Example B1, except that the composition 2 for an AS single layer was changed to the composition 3 for an AS single layer.

### Comparative Example B3

### TAC/AS/HC/AR

The composition for an AR single layer was bar coated onto the surface of the HC layer in the member (optical laminate) produced in Comparative Example B2, and the coating was dried at 50° C. to remove the solvent. Thereafter, the coating film was cured by ultraviolet irradiation with an ultraviolet irradiation system at an integrated light quantity of 200 mJ/cm² to provide a member (optical laminate).

### Comparative Example B4

### TAC/AG/AR

A member (optical laminate) was produced in quite the same manner as in Example B9, except that the composition for an AS+HC+AR single layer was changed to the composition for an AR single layer.

### Comparative Example B5

### TAC/AS/AG/AR

A transparent base material (thickness 80 μm, a triacetylcellulose resin film (manufactured by Fuji Photo Film Co., Ltd., tradename “TF80UL”) was provided. The composition 2 for an AS single layer was bar coated onto one side of the base material, and the assembly was held in a hot oven of 50° C. for 30 sec to evaporate the solvent contained in the coating film and to cure the coating film. Thus, a transparent AS layer having a thickness of about 100 nm (on a dry basis) was formed. Thereafter, the composition for an AG single layer was coated onto the AS layer, and the assembly was held in a hot oven of 70° C. for 30 sec to evaporate the solvent contained in the coating film. The coating film was then cured by ultraviolet irradiation at an integrated light quantity of 50 mJ/cm² to stack an AG layer. Further, the composition for an AR single layer was bar coated onto the surface of the AG layer, and the coating was dried at 50° C. to remove the solvent. Thereafter, the coating film was cured by ultraviolet irradiation with an ultraviolet irradiation system at an integrated light quantity of 200 mJ/cm² to provide a member (optical laminate).

Evaluation Tests

For the members (optical laminates) of Examples B and Comparative Examples B, the surface resistance values (Ω/cm²) after the following tests were measured and were described in Table 2. The surface resistance values (Ω/cm²) were measured with a surface resistivity measuring apparatus (manufactured by Mitsubishi Chemical Corporation, product No.; Hiresta IP MCP-HT260). In the table, ion means 1×10ⁿ Ω/cm².

Evaluation 1: Initial Surface Resistance Measuring Test

Before carrying out a heat resistance test, a lightfastness test, and a moist heat resistance test, the surface resistance values were measured with the above measuring apparatus. When the surface resistance value is less than the order of 10¹⁰ Ω/cm², the member was regarded as an acceptable member. On the other hand, when the surface resistance value does not satisfy the above surface resistance value requirement, the member was regarded as an unacceptable member. For the members of Comparative Examples wherein conventional antistatic materials were used, unlike the members of the present invention, none of the members were acceptable.

Evaluation 2: Surface Resistance Value Measurement After Heat Resistance Test

Each member (optical laminate) was allowed to stand in an oven of 90° C. for 250 hr and was then subjected to surface resistance value measurement with the above measuring apparatus.

Evaluation 3: Surface Resistance Value Measurement After Lightfastness Test

Each member (optical laminate) was exposed to carbon arc light for 100 hr with a lightfastness tester (manufactured by Suga Test Instruments Co., Ltd., tradename; Fade Meter) and was then subjected to surface resistance value R2 measurement with the above measuring apparatus to determine an R1 (measured value in evaluation 1)/R2 ratio.

Evaluation 4: Moist Heat Resistance Test

Each member was subjected to a 500-hr lightfastness test under high temperature and high humidity conditions of temperature 80° C. and humidity 90% and was then subjected to surface resistivity R2′ measurement with the measuring apparatus. The ratio of the surface resistivity R1′ before the lightfastness test (measured value in evaluation 1) to the surface resistivity R2′ after the lightfastness test was determined.

Evaluation 5: Level of Coloring of Member (Laminate)

For each member which could have successfully subjected to surface resistance value measurement in evaluation 1, the level of coloring depending upon the antistatic material was visually observed. A member cut into a square shape having a size of 10 cm×10 cm was applied at its four vertexes onto a standard copying paper (manufactured by FUJI XEROX OFFICE SUPPLY Co., Ltd., tradename Ncolor081, size A3 and the like) with a tape. The assembly was visually observed from about 30 cm above the assembly under a fluorescent lamp. A transparent base materials (TAC, PET) used in the production of the members was applied in the same manner as described above, and the observation results were compared. When the color was the same as that of the blank, the member was evaluated as an acceptable member. On the other hand, when the color was other than that in the acceptable member, the member was evaluated as an unacceptable member.

TABLE 2

| | evaluation | | | | |
|---|---|---|---|---|---|
| Example | Evaluation 1 | Evaluation 2 | Evaluation 3 | Evaluation 4 | Evaluation 5 |
| Ex. B1 | 10⁸ | 10⁸ | 1 | 1 | Acceptable |
| Ex. B2 | 10⁸ | 10⁹ | 10 | 1 | Acceptable |
| Ex. B3 | 10⁸ | 10⁸ | 1 | 1 | Acceptable |
| Ex. B4 | 10⁸ | 10⁸ | 1 | 1 | Acceptable |
| Ex. B5 | 10⁸ | 10⁸ | 1 | 1 | Acceptable |
| Ex. B6 | 10⁸ | 10⁸ | 1 | 1 | Acceptable |
| Ex. B7 | 10⁸ | 10⁸ | 1 | 1 | Acceptable |
| Ex. B8 | 10⁸ | 10⁹ | 10 | 1 | Acceptable |
| Ex. B9 | 10⁸ | 10⁹ | 10 | 1 | Acceptable |
| Ex. B10 | 10⁸ | 10⁹ | 10 | 1 | Acceptable |
| Comp. Ex. | 10¹⁰ | 10¹⁰ | 1 | 1 | Unacceptable |
| B1 | | | | | |
| Comp. Ex. | 10¹⁰ | 10¹⁰ | 100 | 10 | Unacceptable |
| B2 | | | | | |
| Comp. Ex. | 10¹⁰ | 10¹² | 100 | 10 | Unacceptable |
| B3 | | | | | |
| Comp. Ex. | — | — | — | — | — |
| B4 | | | | | |
| Comp. Ex. B5 | 10¹⁰ | 10¹⁰ | 1 | 1 | Unacceptable |

In Table 2, “—” means over range.

1. A composition which can simultaneously realize antistatic properties and hard coat properties, the composition comprising:
an electrolyte having antistatic properties; and
a monomer, an oligomer, or a prepolymer having hard coat properties.

2. The composition according to claim 1, wherein the electrolyte is an ionic liquid which is liquid at room temperature.

3. The composition according to claim 2, wherein the ionic liquid is an imidazolium-type, pyridium-type, pyrrolidinium-type, quaternary ammonium-type, or quaternary phosphonium-type canionic material or its salt.

4. The composition according to claim 1, which further comprises one material or a mixture of two or more materials selected from the group consisting of anti-dazzling agents, refractive index regulators, and antifouling agents.

5. An ink composition comprising a composition according to claim 1.

6. A member which can simultaneously realize antistatic properties and hard coat properties, the member comprising:
an electrolyte having antistatic properties; and
a monomer, an oligomer, or a prepolymer having hard coat properties.

7. The member according to claim 6 produced by curing a composition comprising an electrolyte having antistatic properties and a monomer, an oligomer or a prepolymer having hardcoat properties by exposure to heat and/or an ionizing radiation.

8. The member according to claim 7, wherein the electrolyte is dispersed in the monomer, oligomer, or prepolymer, and
the dispersed electrolyte is present in a tightly bound state in a three-dimensional network structure produced by curing the monomer, oligomer, or prepolymer by exposure to heat and/or an ionizing radiation.

9. A laminate comprising a base material and an optical function layer provided on the base material, wherein
the optical function layer is a member according to claim 6.

10. The laminate according to claim 9, which further comprises one layer or at least two layers, selected from the group consisting of an anti-dazzling layer, a refractive index modulating layer, and an antifouling layer, on the surface of the optical function layer or between the base material and the optical function layer, and/or on the optical function layer.

11. An antistatic composition comprising an electrolyte having antistatic properties and a resin.

12. The antistatic composition according to claim 11, wherein the electrolyte is an ionic liquid which is liquid at room temperature.

13. The antistatic composition according to claim 12, wherein the ionic liquid is an imidazolium-type, pyridium-type, pyrrolidinium-type, quaternary ammonium-type, or quaternary phosphonium-type canionic material or its salt.

14. The antistatic composition according to claim 11, which further comprises one material or a mixture of two or more materials selected from the group consisting of anti-dazzling agents, refractive index regulators, and antifouling agents.

15. An ink composition comprising an antistatic composition according to claim 11.

16. An antistatic member comprising an electrolyte having antistatic properties and a resin.

17. An antistatic member having antistatic properties and a resin which is produced from a composition according to claim 11.

18. A laminate comprising a base material and an optical function layer provided on the base material, wherein
the optical function layer is an antistatic member according to claim 16.

19. The laminate according to claim 18, which further comprises one layer or at least two layers, selected from the group consisting of an anti-dazzling layer, a refractive index modulating layer, and an antifouling layer, on the surface of the optical function layer or between the base material and the optical function layer, and/or on the optical function layer.

20. A polarizing plate comprising a polarizing element and one of a member which can simultaneously realize antistatic properties and hardcoat properties, the member comprising an electrolyte having antistatic properties and a monomer, an oligomer or a prepolymer having hardcoat properties, and a laminate according to claim 9 provided on the surface of the polarizing element.

21. An image display device comprising:
a transmission display; and
a light source device for applying light to the transmission display from its backside;
wherein one of a laminate comprising a base material and an optical function layer provided on the base material, the optical function layer being a member which can simultaneously realize antistatic properties and hardcoat properties and which comprises an electrolyte having antistatic properties and a monomer, an oligomer or a prepolymer having hardcoat properties, and a polarizing plate according to claim 20 is provided on the surface of the transmission display.

22. A laminate comprising a base material and an optical function layer provided on the base material, wherein the optical function layer is a member according to claim 8.
